(19) United States
(12) Patent Application Publication
(10) Pub. No.: US 2026/0368958 A1
(43) Pub. Date: Nov. 19, 2026

(54) INFORMATION PROCESSING DEVICE, PROGRAM, AND INFORMATION PROCESSING METHOD

(71) Applicant: SONY SEMICONDUCTOR SOLUTIONS CORPORATION, KANAGAWA (JP)

(72) Inventors: TOSHINOBU AOKI, KANAGAWA (JP); MOTONOBU FUJIOKA, KANAGAWA (JP)

(21) Appl. No.: 19/153,639

(22) PCT Filed: Jan. 25, 2024
(86) PCT No.: PCT/JP2024/002168

§ 371 Date: Aug. 5, 2025

(30) Foreign Application Priority Data
Feb. 22, 2023 (JP) 2023-025714

(51) Int. Cl. G06T 11/26; G06F 3/14; G06T 11/10

(52) U.S. Cl. CPC G06T 11/26; G06F 3/14; G06T 11/10

(57) ABSTRACT

An information processing device according to the present technology includes a display control unit that causes a superimposed image in which distance information to a subject is superimposed on a luminance image generated on the basis of luminance information about reflected light from the subject to be displayed in a first area on a display unit, in which a superimposition position of the distance information on the luminance image is set to be a position, on the luminance image, of the subject for which the distance information is obtained. The present technology makes it easy to grasp the correspondence between the luminance image and the distance information at a glance.

### TECHNICAL FIELD

The present technology relates to an information processing device, a program, and an information processing method that perform display control on distance information acquired by a distance measurement sensor.

### BACKGROUND ART

In development of a distance measurement sensor or the like, it is necessary to confirm distance information obtained as a distance measurement result in order to review design or the like.

For example, Patent Document 1 below discloses a technique for suppressing lack of height information and suppressing deterioration in accuracy when a two-dimensional grayscale image is generated on the basis of distance information.

### CITATION LIST

### Patent Document

### Patent Document 1: Japanese Translation of PCT International Application Publication No. 2015-021756

### SUMMARY OF THE INVENTION

### Problems to be Solved by the Invention

By the way, in the technology disclosed in Patent Document 1, in a case where it is desired to emphasize a distance with respect to an area where a fine pattern or the like is applied in a grayscale image for the distance information, it is difficult to specify a place where the pattern exists from the grayscale image, and it is difficult to perform work.

The present technology has been made in view of such circumstances, and an object thereof is to provide an environment in which it is easy to confirm distance information in development of a distance measurement sensor or the like.

### Solutions to Problems

An information processing device according to the present technology includes a display control unit that causes a superimposed image in which distance information to a subject is superimposed on a luminance image generated on the basis of luminance information about reflected light from the subject to be displayed in a first area on a display unit, in which a superimposition position of the distance information on the luminance image is set to be a position, on the luminance image, of the subject for which the distance information is obtained.

The luminance image is, for example, a color image such as an RGB image or a monochrome image. Furthermore, the superimposition of the distance information may be performed by superimposing characters or by superimposing images.

This makes it easy to grasp the correspondence between the luminance image and the distance information at a glance.

### BRIEF DESCRIPTION OF DRAWINGS

FIG. 1 is a block diagram illustrating a configuration example of an information processing system.

FIG. 2 is a schematic diagram illustrating a configuration example of a light emitting unit included in a distance measurement camera.

FIG. 3 is a schematic diagram for describing a light receiving area that receives light reflected by a light emitting unit in a distance measurement sensor included in a distance measurement camera.

FIG. 4 is a diagram illustrating an example of a superimposed image.

FIG. 5 is a diagram illustrating a flow of correction processing of distance information together with a simple illustration.

FIG. 6 is a diagram illustrating an example of a first screen.

FIG. 7 is a diagram illustrating a display mode of a second area of the first screen in a case where a control button is pressed.

FIG. 8 is a flowchart illustrating a flow of processing executed by a control unit regarding display of the first screen.

FIG. 9 is a diagram illustrating an example of a second screen.

FIG. 10 is a flowchart illustrating a flow of processing executed by the control unit regarding display of the second screen.

FIG. 11 is a diagram illustrating an example of a third screen.

FIG. 12 is a flowchart illustrating a flow of processing executed by the control unit regarding display of the third screen.

FIG. 13 is a diagram illustrating another example of the third screen.

FIG. 14 is a flowchart illustrating a flow of processing executed by the control unit regarding display of another example of the third screen.

FIG. 15 is a diagram illustrating an example of a fourth screen.

FIG. 16 is an enlarged view illustrating a fifth area on the fourth screen.

FIG. 17 is a diagram illustrating a state in which a plurality of light receiving areas is selected in an individual selection field on the fourth screen.

FIG. 18 is a diagram for describing a state in which an icon image near a cursor is automatically selected on a superimposed image on the fourth screen.

FIG. 19 is a diagram for describing a state in which a plurality of icon images near a cursor is automatically selected on a superimposed image of the fourth screen.

FIG. 20 is a diagram illustrating a state in which a histogram is enlarged and displayed in a histogram area of the fourth screen, and is a diagram illustrating a state in which a plurality of the histograms is selected.

FIG. 21 is a diagram illustrating a state in which a light receiving area is highlighted in the individual selection field on the fourth screen corresponding to the selected histogram.

FIG. 22 is a flowchart illustrating a flow of processing executed by the control unit regarding display of the fourth screen.

FIG. 23 is a flowchart illustrating an example of selective display of an icon image and display processing of a histogram related to the icon image.

FIG. 24 is a flowchart illustrating another example of selective display of an icon image and display processing of a histogram related to the icon image.

FIG. 25 is a diagram illustrating an example of histogram animation.

FIG. 26 is a diagram for describing a trajectory of a cursor by a user operation on a superimposed image of a fifth screen.

FIG. 27 is a diagram illustrating another example of histogram animation.

FIG. 28 is a diagram illustrating an example of a selection area set by a user.

FIG. 29 is a diagram illustrating a state in which an icon image having a large change in distance information in the selection area is automatically selected.

FIG. 30 is a flowchart illustrating a flow of processing executed by the control unit regarding display of the fifth screen.

FIG. 31 is a flowchart for describing that automatic selection processing in the selection area is performed after the start of the animation.

### MODE FOR CARRYING OUT THE INVENTION

Hereinafter, embodiments will be described in the following order.
<1. Configuration of information processing system>
<2. Superimposed image>
<3. Various screens>
<3-1. First example>
<3-2. Second example>
<3-3. Third example>
<3-4. Fourth example>
<3-5. Fifth example>
<4. Others>
<5. Summary>
<6. Present technology>

### 1. Configuration of Information Processing System

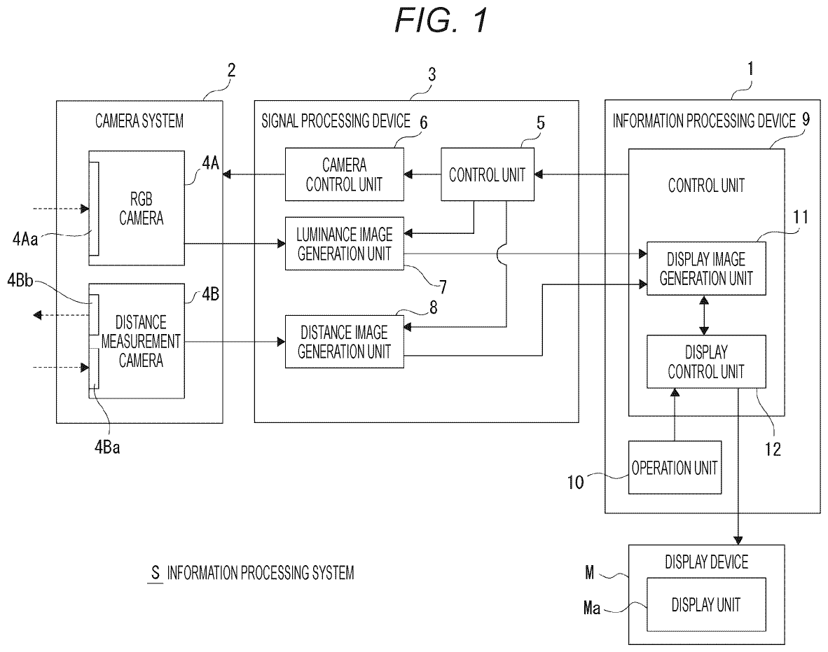

FIG. 1 illustrates a configuration example of an information processing system S including an information processing device 1 according to an embodiment of the present technology.

The information processing system S includes an information processing device 1, a camera system 2, a signal processing device 3, and a display device M.

The camera system 2 includes a plurality of camera devices 4. The camera system 2 in the present example includes an RGB camera 4A that outputs an imaging signal for generating a color image as a luminance image, and a distance measurement camera 4B that outputs an imaging signal according to a distance to a subject.

The RGB camera 4A includes an RGB sensor 4Aa in which pixels having sensitivity to red (R) light, green (G) light, and blue (B) light are two-dimensionally arranged, and optical components such as a lens group (not illustrated).

The RGB camera 4A is an aspect of the camera device for generating a luminance image. As another aspect of the RGB camera 4A, for example, a camera device having a color filter other than RGB, such as a color filter having sensitivity to cyan (Cy) light, magenta (Mg) light, and yellow (Ye) light, may be used. Furthermore, not only a camera device that captures a color image but also a camera device that captures a monochrome image may be adopted instead of the RGB camera 4A.

The distance measurement camera 4B includes a distance measurement sensor 4Ba in which distance measurement pixels are two-dimensionally arranged in order to measure the distance to the subject for each pixel.

Various methods of distance measurement by the distance measurement camera 4B can be considered. For example, a distance measurement camera 4B that performs distance measurement by a time of flight (ToF) method or a distance measurement camera 4B that performs distance measurement by an image plane phase difference method may be used.

In the present example, a distance measurement camera 4B that performs distance measurement by the ToF method, more specifically, distance measurement by a direct ToF (dToF) method will be described as an example.

The distance measurement camera 4B includes a light emitting unit 4Bb in addition to the distance measurement sensor 4Ba. Optical components such as a lens group (not illustrated) are disposed on a subject side of the distance measurement sensor 4Ba and the light emitting unit 4Bb.

The light emitting unit 4Bb has, for example, a configuration in which light emitting elements L such as light emitting diodes (LEDs) are two-dimensionally arranged. Each of the light emitting elements L can emit, for example, infrared light.

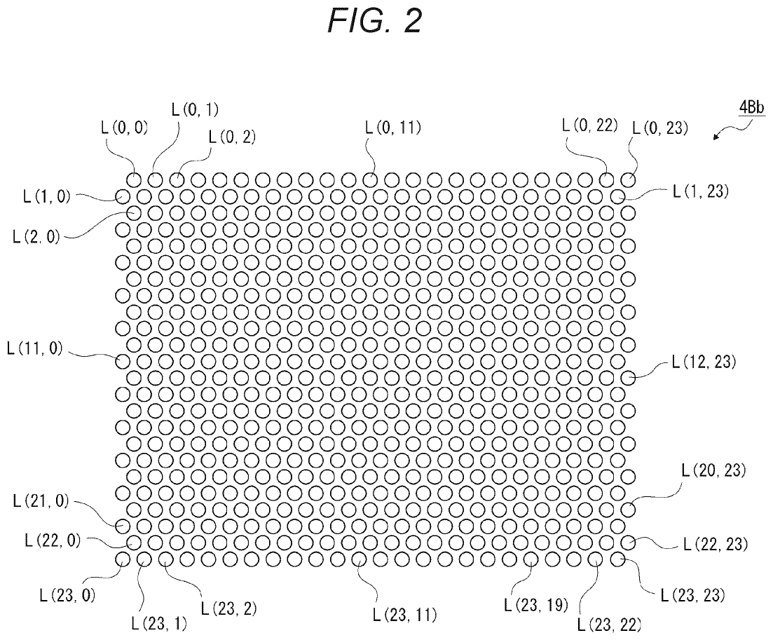

A configuration example of the light emitting unit 4Bb is illustrated in FIG. 2. In this example, the light emitting unit 4Bb has a configuration in which 24 light emitting elements L are two-dimensionally arranged in each of the horizontal direction and the vertical direction.

Although various arrangement modes of the light emitting elements L can be considered, in the present example, one light emitting element L is disposed so as to be surrounded by six adjacent light emitting elements L as illustrated in FIG. 2. In other words, the light emitting element L is disposed at each intersection of the honeycomb structure.

The light emitting element L disposed in the nth row and the mth column is referred to as a light emitting element L (n, m). Furthermore, the variables n and m in this example are integers from 0 to 23, respectively.

That is, the light emitting unit 4Bb includes a total of 576 light emitting elements L from the light emitting element L(0, 0) disposed at the upper left to the light emitting element L(23, 23) disposed at the lower right.

The distance measurement sensor 4Ba of the distance measurement camera 4B is configured by two-dimensionally arranging single photon avalanche diode (SPAD) elements as distance measurement pixels.

Each SPAD element has sensitivity only to infrared light corresponding to the light emitting element L. Consequently, the SPAD element mainly receives infrared light emitted from the light emitting element L and reflected by the subject.

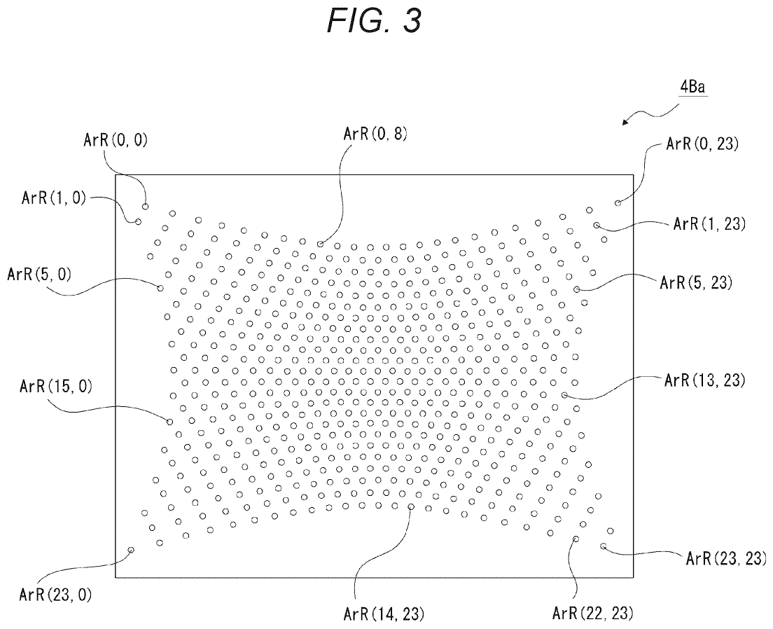

FIG. 3 schematically illustrates a light receiving area ArR that receives infrared light emitted from each light emitting element L included in the light emitting unit 4Bb.

As illustrated, the light receiving areas ArR can be provided as many as the number of light emitting elements L. However, in a case where the infrared light passes outside the range of the distance measurement sensor 4Ba, the light receiving area ArR is smaller than the light emitting element L.

Assuming that the light receiving area ArR of the nth row and the mth column is a light receiving area ArR (m, n), a maximum of 576 light receiving areas ArR are generated from the upper left light receiving area ArR (0, 0) to the lower right light receiving area ArR (23, 23).

Note that the light receiving area ArR corresponding to the light emitting element L(0, 0) may be a light receiving area ArR (0, 0), a light receiving area ArR (0, 23), a light receiving area ArR (23, 0), or a light receiving area ArR (23, 23). That is, the correspondence between the light emitting element L and the light receiving area ArR may be different depending on the configuration of the optical components included in the distance measurement camera 4B.

One light receiving area ArR may include one pixel (SPAD element) or a plurality of pixels.

An imaging signal for generating a color luminance image is output from the RGB camera 4A to the signal processing device 3 in the subsequent stage.

Furthermore, an imaging signal for generating a distance image is output from the distance measurement camera 4B to the signal processing device 3 in the subsequent stage.

The signal processing device 3 includes a control unit 5, a camera control unit 6, a luminance image generation unit 7, and a distance image generation unit 8.

The control unit 5 causes the camera control unit 6, the luminance image generation unit 7, and the distance image generation unit 8 to execute predetermined processing in response to an instruction from the information processing device 1.

The camera control unit 6 causes the RGB camera 4A and the distance measurement camera 4B included in the camera system 2 to execute an imaging operation to output an imaging signal from each camera.

The luminance image generation unit 7 performs various types of signal processing such as demosaic processing and various types of correction processing on the imaging signal output from the RGB camera 4A, and generates a luminance image G1 as a color image. The luminance image generation unit 7 supplies the generated luminance image G1 to the information processing device 1.

The distance image generation unit 8 generates a histogram using a plurality of imaging signals output from the distance measurement camera 4B, and generates distance information DI to the subject for each light receiving area ArR (or for each pixel) using a time difference from light emission to light reception, a light speed, and the like.

The distance image generation unit 8 supplies information in which the distance information DI is associated with each light receiving area ArR to the information processing device 1 as a distance image G2.

The information processing device 1 includes a control unit 9 and an operation unit 10.

The control unit 9 realizes generation of each image in the signal processing device 3 by transmitting various commands to the signal processing device 3. Furthermore, the control unit 9 controls the camera system 2 via the signal processing device 3.

The control unit 9 includes a display image generation unit 11 and a display control unit 12.

The display image generation unit 11 has a function of generating an image to be displayed on a display unit Ma of the display device M. The image generated by the display image generation unit 11 includes a superimposed image G3 obtained by superimposing the distance information DI on the luminance image G1. The superimposed image G3 will be described later again.

The display control unit 12 has a function of causing the display unit Ma of the display device M to display various images such as the distance image G2 and the superimposed image G3 generated by the display image generation unit 11, and GUIs as various applications.

Here, the information processing system S in the present example is a system used for development and manufacturing inspection of the distance measurement sensor 4Ba included in the distance measurement camera 4B.

That is, the information processing system S is a system used by the user to confirm the accuracy of the distance information DI generated by the distance measurement sensor 4Ba.

Consequently, by displaying the image generated by the display image generation unit 11 on the display unit Ma of the display device M, the user can efficiently perform development work and the like of the distance measurement sensor 4Ba.

The operation unit 10 is various operation means such as a mouse, a keyboard, or a touch panel operated by a user who uses the information processing device 1.

### 2. Superimposed Image

The superimposed image G3 will be described. The superimposed image G3 is obtained by superimposing the distance information DI on the luminance image G1 generated by the luminance image generation unit 7.

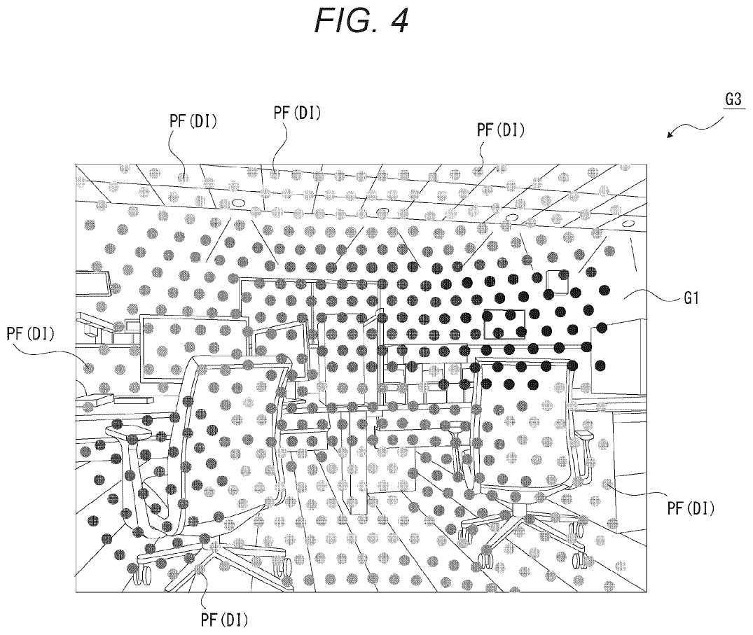

An example of the superimposed image G3 is illustrated in FIG. 4.

As illustrated, in the superimposed image G3, the distance information DI calculated according to the light reception result in each light receiving area ArR of the distance measurement sensor 4Ba is superimposed on the luminance image G1.

The superimposition of each distance information DI is realized, for example, by superimposing an icon image PF of the display color corresponding to the measured distance. In FIG. 4, instead of changing the display color of the icon image PF according to the distance for convenience of display of the drawing, the icon image PF is represented by black and white shading. Furthermore, in the distance information DI, a large circular icon image PF is displayed for easy viewing in the drawing. The present technology is not limited thereto, and an icon image PF having a circular shape smaller than that in FIG. 4 may be superimposed on the luminance image G1 so that the luminance image G1 portion in the superimposed image G3 can be easily seen.

Furthermore, in the example illustrated in FIG. 4, the distance information DI is expressed by the display color of the icon image PF, but the distance information DI may be expressed by the size of the icon image PF. For example, the size of the icon image PF may be increased as the distance is shorter (closer).

In addition, various modes such as expressing the distance information DI by the height of the transparency of the icon image PF can be considered.

The superimposition position of the distance information DI is a position based on the position of the subject.

Here, the display image generation unit 11 executes processing for calculating the superimposition position of the distance information DI on the luminance image G1, thereby generating the superimposed image G3 in which the distance information DI is superimposed on an appropriate position of the luminance image G1.

That is, the display image generation unit 11 performs processing of converting the position of the light receiving area ArR, which is the area on the distance measurement sensor 4Ba and receives the reflected light from the subject, to the superimposition position on the luminance image G1. This processing is referred to as distance information correction processing.

Note that, in the following description, the distance information before the correction processing is described as pre-processing distance information DIa.

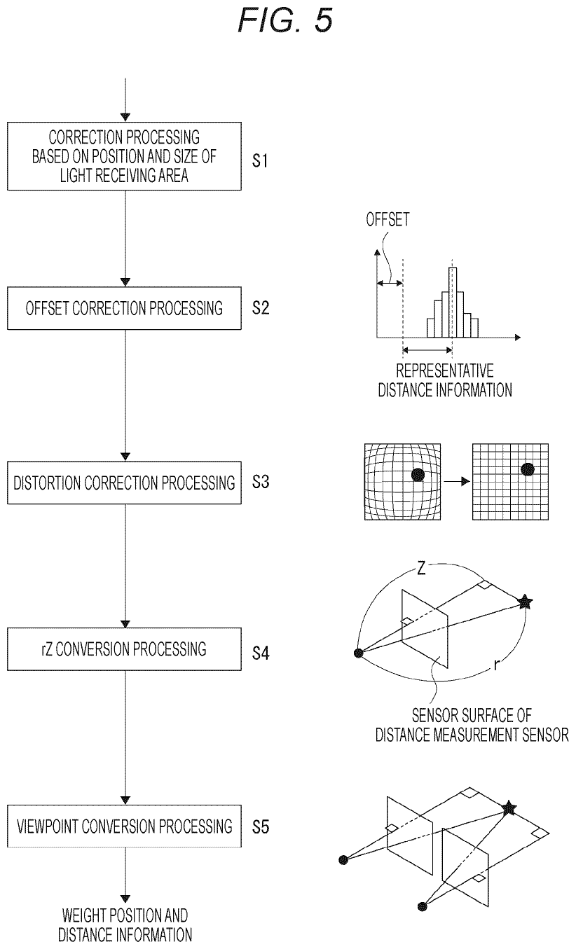

FIG. 5 illustrates a rough flow of the distance information correction processing.

The display image generation unit 11 first performs correction processing based on the position and size of the light receiving area ArR on the pre-processing distance information DIa that is the distance information before correction (step S1). In this correction processing, a histogram is generated on the basis of individual distance information (here, unit distance information) obtained for each light emission of the light emitting element L corresponding to the light receiving area ArR to be processed.

Subsequently, the display image generation unit 11 performs offset correction processing using the information on the light emission timing (step S2). This processing is processing of subtracting the offset time, which is the time from the measurement start timing to the actual light emission timing of the light emitting element L, from the distance information calculated by the time difference from the measurement start timing of the time to the light reception timing of the reflected light.

Furthermore, in the offset correction processing, the peak value of the histogram generated from each unit distance information is determined as the representative distance information for the light receiving area ArR.

Next, the display image generation unit 11 performs distortion correction processing of removing lens distortion and the like caused by a lens group or the like provided on the subject side of the distance measurement sensor 4Ba with respect to the representative distance information (step S3).

Subsequently, the display image generation unit 11 performs rZ conversion processing (step S4). In the rZ conversion processing, the distance r between the light receiving area ArR and the subject in the distance measurement sensor 4Ba is converted into the distance Z between the surface including the distance measurement sensor 4Ba and the surface parallel to the surface and including the subject.

Finally, the display image generation unit 11 performs viewpoint conversion processing (step S5). The viewpoint conversion processing is conversion in consideration of a difference in position between the distance measurement sensor 4Ba and the RGB sensor 4Aa, and obtains an imaging position and a distance of a subject in the RGB sensor 4Aa.

In other words, the processing in step S5 is processing of obtaining the corresponding point of the light receiving area ArR of the distance measurement sensor 4Ba on the RGB sensor 4Aa, and further converting the distance Z into the distance between the surface including the RGB sensor 4Aa and the surface including the subject.

By performing such processing, the superimposition position on the luminance image G1 and the distance information DI after the correction processing are calculated. Furthermore, the display image generation unit 11 generates the superimposed image G3 illustrated in FIG. 5 by superimposing the distance information DI on the superimposition position on the luminance image G1.

### 3. Various Screens

Some examples of screens displayed on the display unit Ma of the display device M and display control will be described with reference to the attached drawings.

### 3-1. First Example

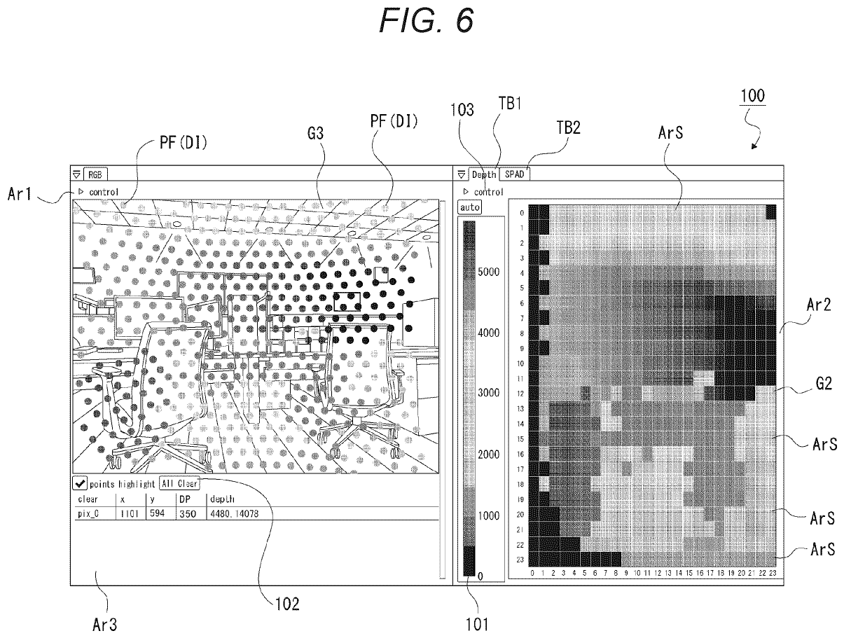

FIG. 6 illustrates a first example of a screen displayed on the display unit Ma.

A first screen 100 displayed on the display unit Ma in the first example includes three areas of a first area Ar1, a second area Ar2, and a third area Ar3. Each area is, for example, a window-type area, and can be moved in position, changed in size, and the like.

Each area may be disposed so as not to overlap each other, or may be disposed so that each partial area overlaps by enlarging and reducing the window.

The first area Ar1 is an area where the superimposed image G3 is displayed. Each icon image PF (distance information DI) superimposed on the superimposed image G3 of the first area Ar1 can be a target of the selection operation by the user.

The second area Ar2 includes a first tab TB1 (“Depth” in the drawing) and a second tab TB2 (“SPAD” in the drawing). FIG. 6 illustrates a state in which the first tab TB1 is selected, and the distance image G2 and a legend 101 are displayed.

The distance image G2 is formed by arranging rectangular small areas ArS in a matrix. Each of the small areas ArS corresponds to each of the light receiving areas ArR, and the display color is a color based on the distance information DI for the light receiving area ArR. For example, the display color of the icon image PF corresponding to the display color of the light receiving area ArR is the same color.

The legend 101 indicates the correspondence between the display color of the small area ArS and the distance information. Furthermore, the memory value horizontally attached to the legend 101 represents distance information in units of mm.

When the second tab TB2 is selected, RAW data output from the SPAD pixel as the distance measurement pixel of the distance measurement sensor 4Ba is displayed in the second area Ar2 (not illustrated).

The third area Ar3 is an area in which information about the distance information DI is displayed.

In a case where one icon image PF superimposed on the superimposed image G3 or the small area ArS in the distance image G2 is selected by the selection operation by the user, various information related to the distance information DI associated with the icon image PF or the small area Ars to be selected is displayed in the third area Ar3.

A plurality of pieces of the distance information DI can be displayed in the third area Ar3. Every time the user selects the icon image PF or the small area ArS, a selection ID (Identification) is assigned.

Furthermore, in the third area Ar3, one record is displayed for each selection ID. In FIG. 6, a record to which a selection ID of “pix_0” is assigned is displayed.

Each record includes coordinate information (“x” and “y” in the drawing) indicating a position on the superimposed image G3 (or the luminance image G1), a serial ID (“DP” in the drawing) assigned to each distance information DI, and the distance information DI (“depth” in the drawing).

When the distance information DI corresponding to the light receiving area ArR (m, n) is the distance information DI (m, n), the serial ID is an ID assigned without overlapping with each distance information DI from the distance information DI (0, 0) to the distance information DI (23, 23).

The distance information DI is represented by a numerical value of a unit “mm”.

A character string (“pix_0” in the drawing) of the selection ID is an operation button, and in a case where the character string is a target of the click operation of the user, the record is deleted from the third area Ar3.

The third area Ar3 is provided with an all clear button 102 for deleting all records.

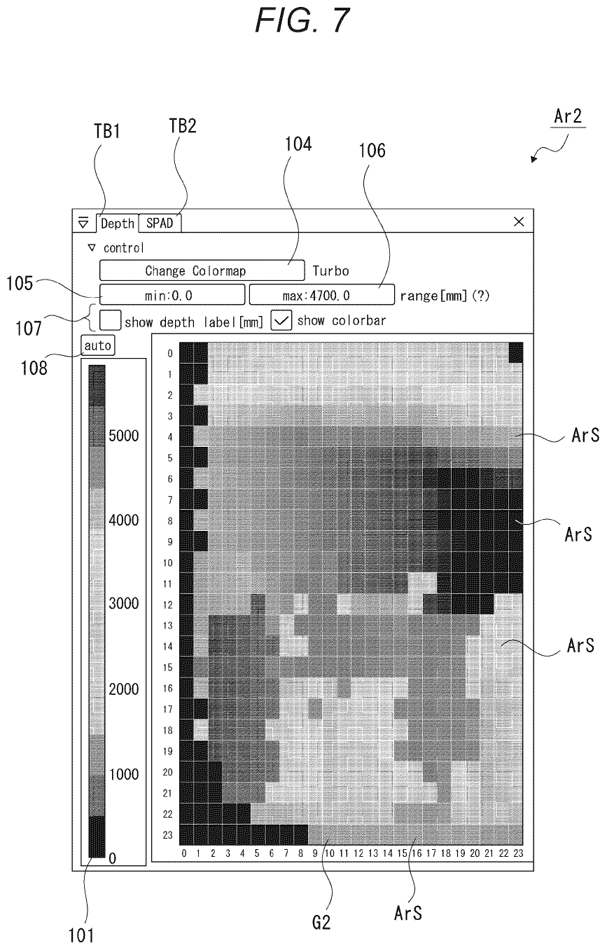

In the second area Ar2, a control button 103 (“control” in the drawing) is disposed above the legend 101. When the control button 103 is pressed, as illustrated in FIG. 7, a color change button 104 for changing the relationship between the distance and the color in the legend 101, a lower limit input field 105 and an upper limit input field 106 for determining an upper limit value and a lower limit value of the legend 101, a display change operation field 107 for changing the display method of the legend 101, and an automatic button 108 are displayed in the second area Ar2.

Furthermore, in the second area Ar2 after the control button 103 is pressed, the legend 101 and the distance image G2 displayed before the control button 103 is pressed are displayed.

The user can improve the efficiency of the debugging work by increasing the color assigned to the distance to be checked in detail in the distance information DI.

For example, when “3000” is input in the lower limit input field 105 and “3500” is input in the upper limit input field 106, the display mode can be changed to a display mode (non-linear display) in which the difference in the distance information DI for the subject located from 3 m to 3.5 m can be easily seen.

That is, the user can change the correspondence relationship between the distance information DI and the display color.

The automatic button 108 is provided both before (FIG. 6) and after (FIG. 7) the control button 103 is pressed. The automatic button 108 is an operator for returning the correspondence between the distance information DI of the legend 101 and the display color to the linear display mode (linear display).

That is, the automatic button 108 is an operator for changing the display mode to a display mode in which the display color changes linearly between the minimum distance information DI and the maximum distance information DI included in the distance image G2.

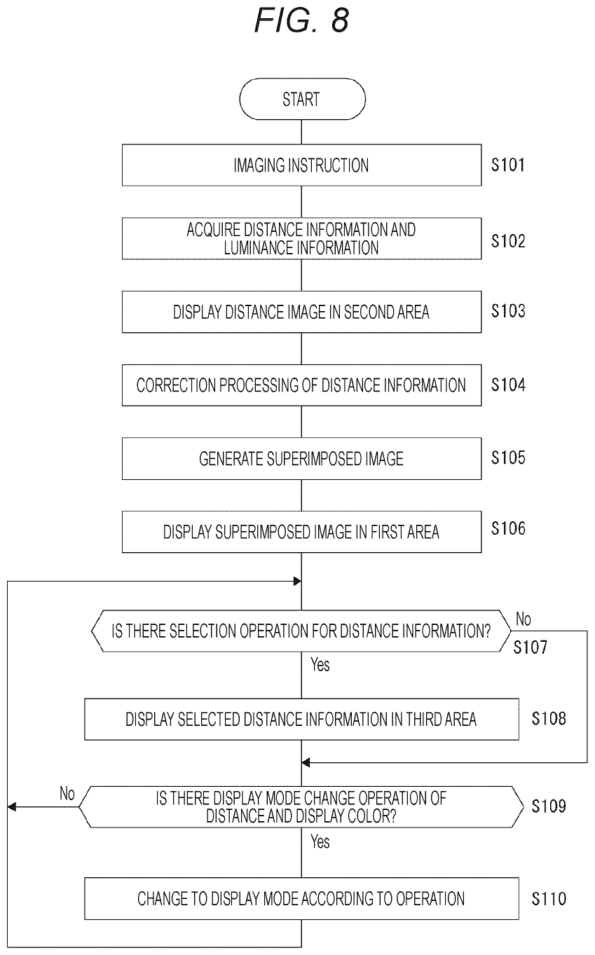

FIG. 8 illustrates an example of processing executed by the control unit 9 of the information processing device 1 in the present example. Note that the processing illustrated in FIG. 8 illustrates a part of the processing executed by each part of the control unit 9, and the control unit 9 executes processing for detecting an operation performed by the user and processing corresponding to the user operation in addition to this.

The control unit 9 first issues an imaging instruction to the camera system 2 in step S101. Therefore, the imaging operation is executed by the RGB camera 4A and the distance measurement camera 4B included in the camera system 2.

Next, in step S102, the control unit 9 requests the signal processing device 3 to acquire distance information and luminance information. In response to this, the signal processing device 3 generates the luminance image G1 on the basis of the imaging signal output from the RGB camera 4A, and generates the distance image G2 on the basis of the imaging signal output from the distance measurement camera 4B.

In step S103, the display control unit 12 of the control unit 9 causes the distance image G2 to be displayed in the second area Ar2. Therefore, the distance image G2 is displayed on the display unit Ma of the display device M.

In step S104, the display image generation unit 11 of the control unit 9 performs correction processing of the pre-processing distance information DIa (see FIG. 5). Therefore, the corrected distance information DI and the superimposition position thereof are calculated.

The display image generation unit 11 of the control unit 9 generates the superimposed image G3 in which the distance information DI is superimposed on the luminance image G1 in step S105.

The display control unit 12 of the control unit 9 causes the superimposed image G3 to be displayed in the first area Ar1 in step S106. Therefore, the distance image G2 and the superimposed image G3 are displayed on the display unit Ma of the display device M (see FIG. 6).

In step S107, the control unit 9 determines the presence or absence of a selection operation for the distance information DI. In a case where the selection operation has not been detected, the control unit 9 avoids the processing of step S108.

On the other hand, in a case where it is determined in step S107 that the selection operation has been detected, the process proceeds to step S108, and the display control unit 12 of the control unit 9 executes processing of causing the selected distance information DI to be displayed in the third area Ar3. Therefore, detailed information on the distance information DI is displayed on the display unit Ma of the display device M in addition to the distance image G2 and the superimposed image G3.

After the determination of “No” in step S107 or after the processing in step S108, the control unit 9 determines whether or not a display mode change operation of the distance and the display color has been detected in step S109. In a case where it is determined that the change operation of the display mode has not been detected, the control unit 9 returns to the processing of step S107 without executing the processing of step S110.

On the other hand, in a case where it is determined that the change operation has been detected, the display control unit 12 of the control unit 9 performs display control so as to achieve a display mode according to the change operation in step S110. Therefore, for example, the display color of the small area ArS in the distance image G2 displayed in the second area Ar2 is changed.

Furthermore, in response to this, the display color of the superimposed icon image PF in the superimposed image G3 displayed in the first area Ar1 is similarly changed.

After ending the processing of step S110, the control unit 9 returns to the processing of step S107.

### 3-2. Second Example

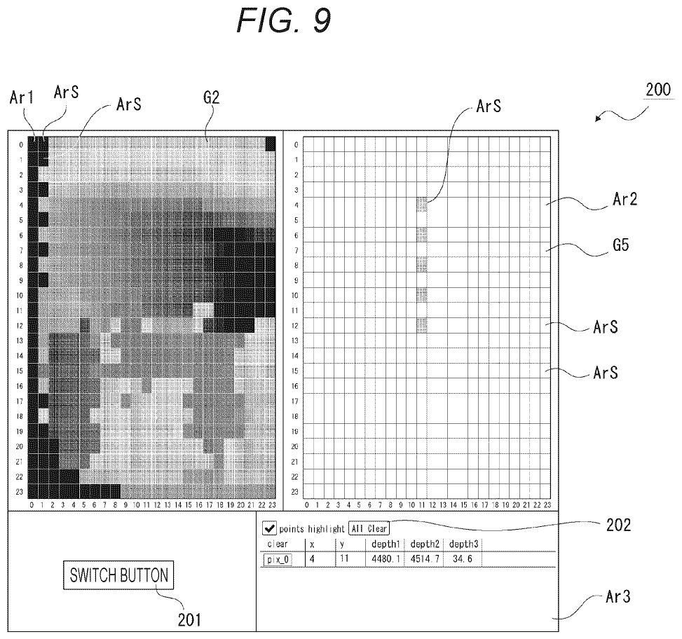

FIG. 9 illustrates a second example of the screen displayed on the display unit Ma.

A second screen 200 displayed on the display unit Ma in the second example includes a first area Ar1, a second area Ar2, and a third area Ar3. Furthermore, a switch button 201 is disposed on the second screen 200.

In the first area Ar1, the distance image G2 in the first example, which is obtained by the distance measurement camera 4B of the camera device 4 performing an imaging operation in accordance with an instruction from the control unit 9, is displayed.

Note that, although the legend is not displayed in the first area Ar1, the legend may be displayed similarly to the first example.

In the second area Ar2, a difference image G5 generated on the basis of the distance image G2 and a reference image G4 is displayed.

First, the reference image G4 will be described.

The reference image G4 is a distance image generated by accurate distance information DI. The accurate distance information DI is the distance information DI regarding the RGB camera 4A and the subject to be obtained by the imaging by the distance measurement camera 4B of the camera system 2 and the correction processing of the pre-processing distance information DIa described above.

The difference between the distance image G2 and the reference image G4 decreases as the distance image G2 is an image generated on the basis of the accurate distance information DI. In other words, the difference from the reference image G4 increases as the distance image G2 includes an error. Here, the distance information in the reference image G4 is referred to as reference distance information DIb.

Next, the difference image G5 will be described.

The difference image G5 is an image generated on the basis of a difference between the distance information DI for each light receiving area ArR in the distance image G2 and the reference distance information DIb for each light receiving area ArR in the reference image G4. The distance image G2, the reference image G4, and the difference image G5 include the same number of small areas ArS.

For example, in the case of the quality inspection performed in the manufacturing process of the distance measurement sensor 4Ba, the user can grasp whether or not the manufacturing error of the distance measurement sensor 4Ba is within an allowable range by checking the difference image G5 displayed in the second area Ar2. Therefore, shipping determination of the distance measurement sensor 4Ba can be appropriately performed.

Furthermore, in the performance inspection performed in the development process of the distance measurement sensor 4Ba, the user can confirm the correctness and improvement of the design of the distance measurement sensor 4Ba by confirming the difference image G5 displayed in the second area Ar2.

Note that the image displayed in the first area Ar1 and the image displayed in the second area Ar2 may be switched and displayed.

Furthermore, a legend may be displayed in the second area Ar2. In the legend, for example, it is preferable to associate the difference value with the display color such that the difference value of each small area ArS in the difference image G5 has a different display color between a positive value and a negative value.

A plurality of pieces of the difference information can be displayed in the third area Ar3. A selection ID is assigned each time the user selects the small area ArS in the distance image G2 of the first area Ar1 or the small area ArS in the difference image G5 of the second area Ar2.

Furthermore, in the third area Ar3, one record is displayed for each selection ID. In FIG. 9, a record to which a selection ID of “pix_0” is assigned is displayed.

Each record includes coordinate information (“x” and “y” in the drawing) indicating the position of the selected small area ArS on the distance image G2 (or the difference image G5), distance information DI (“depth1” in the drawing) and reference distance information DIb (“depth2” in the drawing) for the small area ArS, and difference information (“def” in the drawing).

In this example, the coordinate information is represented by an integer value from 0 to 23.

The distance information DI, the reference distance information DIb, and the difference information are represented by numerical values in units of “mm”.

The character string (“pix_0” in the drawing) of the selection ID in the third area Ar3 is an operation button for deleting the record similarly to the first example.

Furthermore, an all clear button 202 for deleting all records is provided in the third area Ar3.

A switch button 201 is an operator for switching the image displayed in the second area Ar2 between the difference image G5 and the distance image G2. For example, while the switch button 201 is pressed, the distance image G2 is displayed in the second area Ar2, and while the switch button 201 is not pressed, the difference image G5 is displayed in the second area Ar2.

By repeating the pressed state and the unpressed state of the switch button 201, the user can compare the difference image G5 and the distance image G2 displayed in the same area in a time division manner, and can easily confirm which small area ArS in the difference image G5 corresponds to which small area ArS in the distance image G2.

Note that, while the switch button 201 is pressed, the distance image G2 may be displayed in the second area Ar2, and the image displayed in the first area Ar1 may be switched from the distance image G2 to the reference image G4 or the difference image G5.

Furthermore, an operator for switching the image displayed in the first area Ar1 between the distance image G2 and the reference image G4 may be separately provided on the second screen 200.

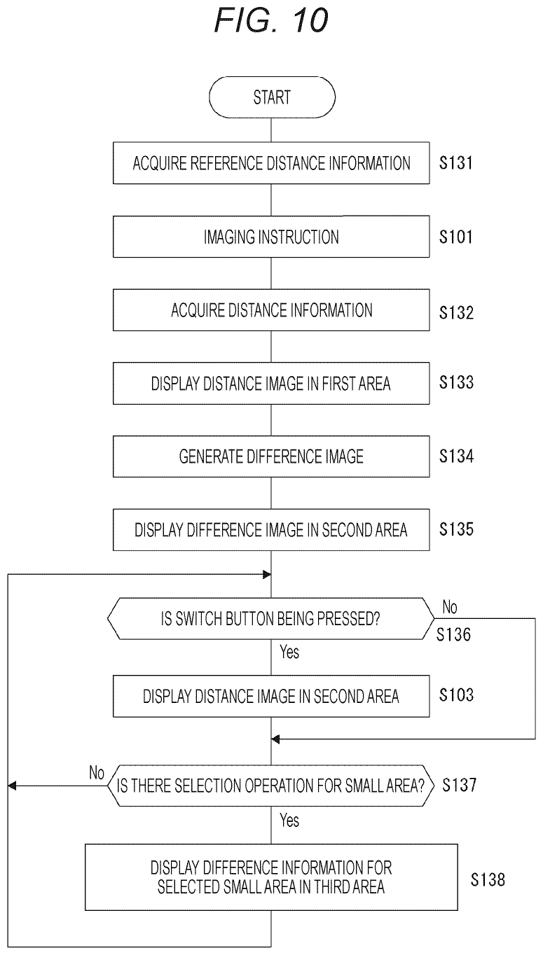

FIG. 10 illustrates an example of processing executed by the control unit 9 of the information processing device 1 in the present example. Note that the processing illustrated in FIG. 10 illustrates a part of the processing executed by each unit of the control unit 9, and the control unit 9 executes processing for detecting an operation performed by the user and processing corresponding to the user operation in addition to this.

Furthermore, processing similar to that illustrated in FIG. 8 will be denoted by the same step number, and description thereof will be omitted as appropriate.

First, the control unit 9 acquires the reference distance information DIb in step S131. The reference distance information DIb acquired here is used to generate the difference image G5, and for example, the reference distance information DIb for each small area ArS of the difference image G5 is acquired.

In step S101, the control unit 9 issues an imaging instruction to the camera system 2.

In step S132, the control unit 9 requests the signal processing device 3 to acquire distance information. In response to this, the signal processing device 3 generates the distance image G2 on the basis of the imaging signal output from the distance measurement camera 4B.

In step S133, the display control unit 12 of the control unit 9 causes the distance image G2 to be displayed in the first area Ar1.

In step S134, the display image generation unit 11 of the control unit 9 generates the difference image G5 from the distance image G2 and the reference image G4.

The display control unit 12 of the control unit 9 causes the difference image G5 to be displayed in the second area Ar2 in step S135.

In step S136, the control unit 9 determines whether or not the switch button 201 is being pressed. In a case where it is determined that the switch button 201 is being pressed, the display control unit 12 of the control unit 9 causes the distance image G2 to be displayed in the second area Ar2 in step S103.

On the other hand, in a case where it is determined that the switch button 201 is not being pressed, the control unit 9 proceeds to step S137 while displaying the difference image G5 in the second area Ar2.

In step S137, the control unit 9 determines the presence or absence of a selection operation for the small area ArS. In a case where it is determined that there is the selection operation, the display control unit 12 of the control unit 9 causes the difference information for the selected small area ArS to be displayed in the third area Ar3 in step S138.

After ending the processing of step S138 or after determining that the selection operation for the small area ArS has not been performed in step S137, the control unit 9 returns to the processing of step S136.

### 3-3. Third Example

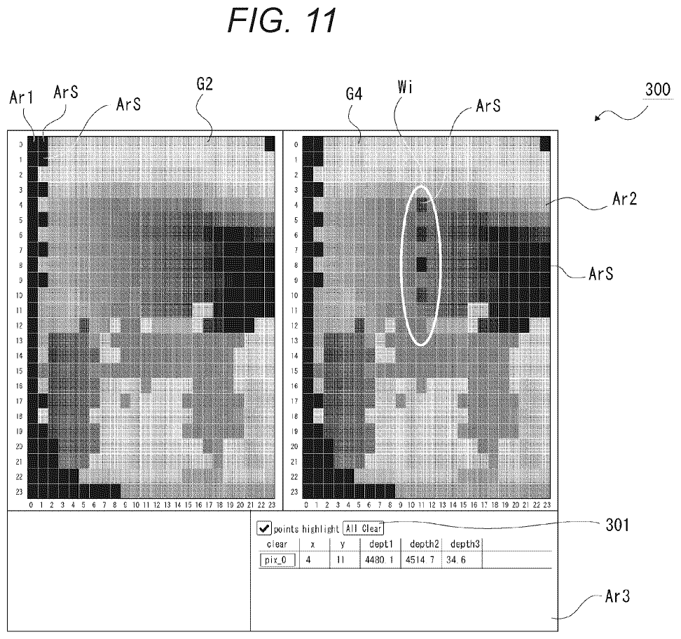

FIG. 11 illustrates a third example of the screen displayed on the display unit Ma.

A third screen 300 displayed on the display unit Ma in the third example includes a first area Ar1, a second area Ar2, and a third area Ar3.

In the first area Ar1, the distance image G2 in the first example, which is obtained by the distance measurement camera 4B of the camera device 4 performing an imaging operation in accordance with an instruction from the control unit 9, is displayed.

In the second area Ar2, a reference image G4 to be compared with the distance image G2 is displayed.

Note that a legend may be displayed in the first area Ar1 and the second area Ar2.

Furthermore, an image for highlighting the small area Ars having a large difference between the reference image G4 and the distance image G2 is superimposed on the second area Ar2. In FIG. 11, an elliptical image is superimposed and displayed so as to surround the five small areas ArS. An image to be superimposed on the reference image G4 is referred to as an “emphasis image Wi”.

A plurality of pieces of the difference information can be displayed in the third area Ar3. A selection ID is assigned each time the user selects the small area ArS in the distance image G2 of the first area Ar1 or the small area ArS in the reference image G4 of the second area Ar2.

In the third area Ar3, one record is displayed for each selection ID. In FIG. 11, a record to which a selection ID of “pix_0” is assigned is displayed.

Since contents of each record are similar to those in the second example, description thereof is omitted.

Note that an all clear button 301 for deleting all records is provided in the third area Ar3.

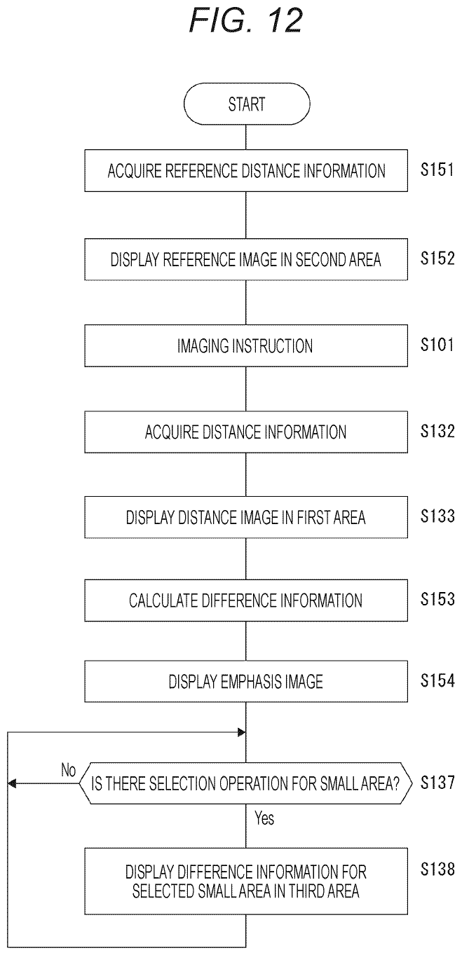

FIG. 12 illustrates an example of processing executed by the control unit 9 of the information processing device 1 in the present example. Note that the processing illustrated in FIG. 12 illustrates a part of the processing executed by each unit of the control unit 9, and the control unit 9 executes processing for detecting an operation performed by the user and processing corresponding to the user operation in addition to this.

Furthermore, processing similar to that illustrated in FIGS. 8 and 10 is denoted by the same step numbers, and description thereof is omitted as appropriate.

The display image generation unit 11 of the control unit 9 first acquires the reference distance information DIb in step S151 and generates the reference image G4.

The display control unit 12 of the control unit 9 causes the reference image G4 to be displayed in the second area Ar2 in step S152.

In step S101, the control unit 9 issues an imaging instruction to the camera system 2.

In step S132, the control unit 9 requests the signal processing device 3 to acquire distance information. In response to this, the signal processing device 3 generates the distance image G2 on the basis of the imaging signal output from the distance measurement camera 4B.

In step S133, the display control unit 12 of the control unit 9 causes the distance image G2 to be displayed in the first area Ar1.

In step S153, the control unit 9 calculates difference information for each of the small areas ArS in the distance image G2 and the reference image G4.

In step S154, the display control unit 12 of the control unit 9 causes the emphasis image Wi to be superimposed and displayed on the reference image G4 of the second area Ar2.

In step S137, the control unit 9 determines the presence or absence of a selection operation for the small area ArS. In a case where it is determined that there is the selection operation, the display control unit 12 of the control unit 9 causes the difference information for the selected small area ArS to be displayed in the third area Ar3 in step S138.

After ending the processing of step S138 or after determining that the selection operation for the small area ArS has not been performed in step S137, the control unit 9 returns to the processing of step S137.

Note that the difference information for the small area ArS having a large difference between the reference image G4 and the distance image G2 in the area surrounded by the emphasis image Wi may be automatically displayed in the third area Ar3.

Alternatively, in a case where a click operation on the emphasis image Wi is detected, the difference information of the small area ArS having a large difference in the area inside the click operation may be displayed in the third area Ar3.

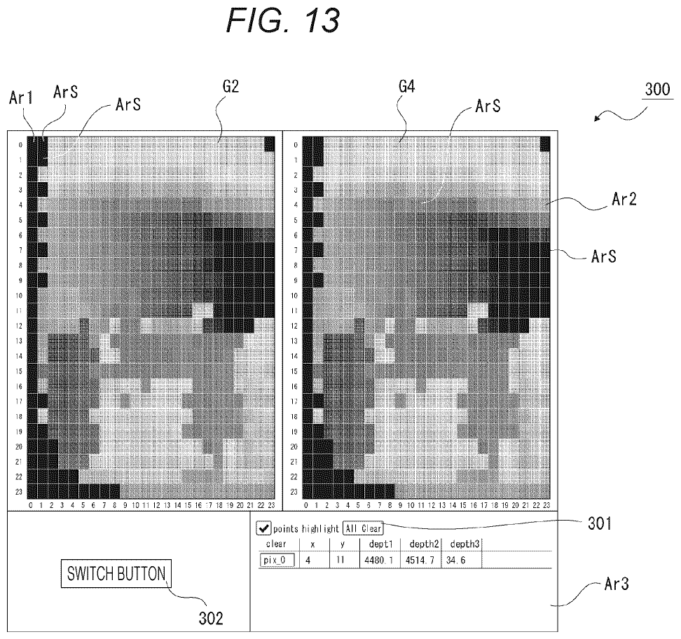

Note that, as illustrated in FIG. 13, a switch button 302 may be disposed on the third screen 300. Furthermore, alternatively, the emphasis image Wi may not be superimposed and displayed in the second area Ar2.

The switch button 302 is an operator for switching the image displayed in the first area Ar1 between the distance image G2 and the reference image G4. For example, while the switch button 302 is being pressed, the reference image G4 is displayed in the first area Ar1, and while the switch button 302 is not being pressed, the distance image G2 is displayed in the first area Ar1.

By repeating the pressed state and the unpressed state of the switch button 302, the user can compare the distance image G2 and the reference image G4 displayed in the same area in a time division manner, and can easily confirm the small area ArS having a large difference in the distance image G2 and the reference image G4 using an afterimage.

Furthermore, this makes it possible to ensure ease of confirmation without superimposing and displaying the emphasis image Wi.

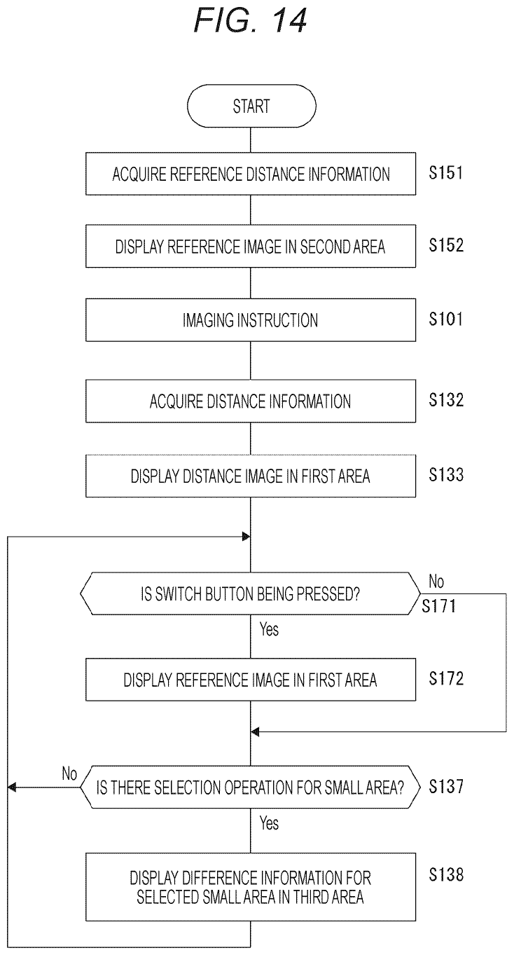

FIG. 14 illustrates an example of processing executed by the control unit 9 of the information processing device 1 to realize the display mode illustrated in FIG. 13. Note that processing similar to that in FIG. 12 is denoted by the same step numbers, and description thereof is omitted as appropriate.

The control unit 9 executes each processing of step S151, step S152, step S101, step S132, and step S133 to cause the reference image G4 to be displayed in the second area Ar2 and the distance image G2 to be displayed in the first area Ar1.

Subsequently, in step S171, the control unit 9 determines whether or not the switch button 302 is being pressed. In a case where it is determined that the pressing is being performed, the display control unit 12 of the control unit 9 causes the reference image G4 to be displayed in the first area Ar1 in step S172.

In a case where it is determined in step S171 that the switch button 302 is not being pressed, or after the processing of step S172 ends, the control unit 9 appropriately executes each processing of steps S137 and S138. Therefore, the difference information is caused to be displayed in the third area Ar3 according to the selection operation for the small area ArS.

### 3-4. Fourth Example

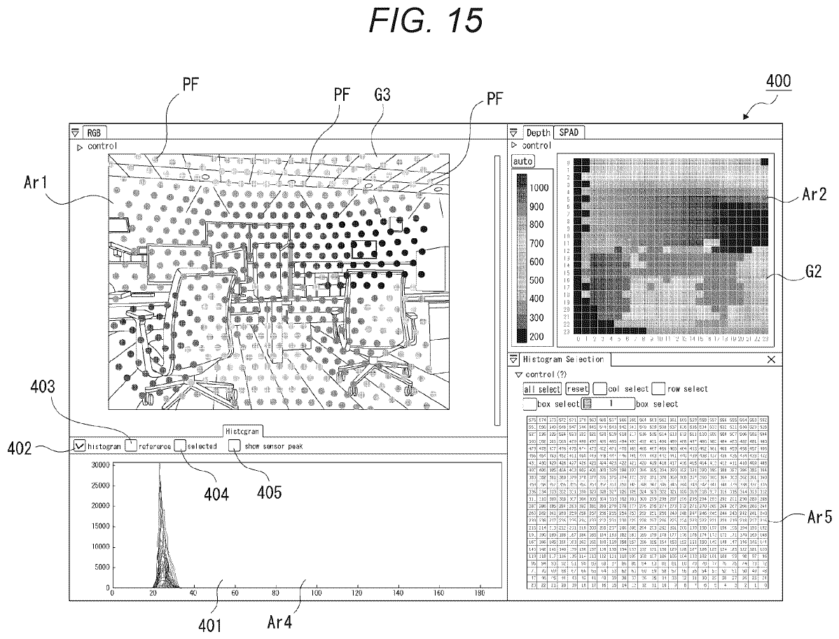

FIG. 15 illustrates a fourth example of the screen displayed on the display unit Ma.

A fourth screen 400 displayed on the display unit Ma in the fourth example includes a first area Ar1, a second area Ar2, a fourth area Ar4, and a fifth area Ar5.

Similarly to the first screen 100 of the first example, a superimposed image G3 is displayed in the first area Ar1, and a distance image G2 is displayed in the second area Ar2.

The fourth area Ar4 is an area where a graph of a histogram for each light receiving area ArR (or for each small area ArS in the range image G2) is displayed. As the histogram displayed in the fourth area Ar4, all of the 576 histograms from the light receiving area ArR (0, 0) to the light receiving area ArR (23, 23) may be displayed, or some of the histograms may be displayed.

In the fourth area Ar4, a histogram display area 401, a histogram button 402 for displaying histograms for all the light receiving areas ArR, a reference button 403 for displaying zero-order light, a selection display button 404 for displaying only the selected histogram, and a peak button 405 for displaying a peak value of the histogram are displayed.

In the histogram display area 401, an operation for enlarging and reducing the corresponding portion in the histogram is possible.

The zero-order light refers to light that is reflected by a lens group or the like disposed in front of the light emitted from the light emitting unit 4Bb of the distance measurement camera 4B and is received by the distance measurement sensor 4Ba. That is, the zero-order light is a component that becomes noise of the distance measurement result.

The fifth area Ar5 is an operation area for selecting a histogram to be displayed in the fourth area Ar4.

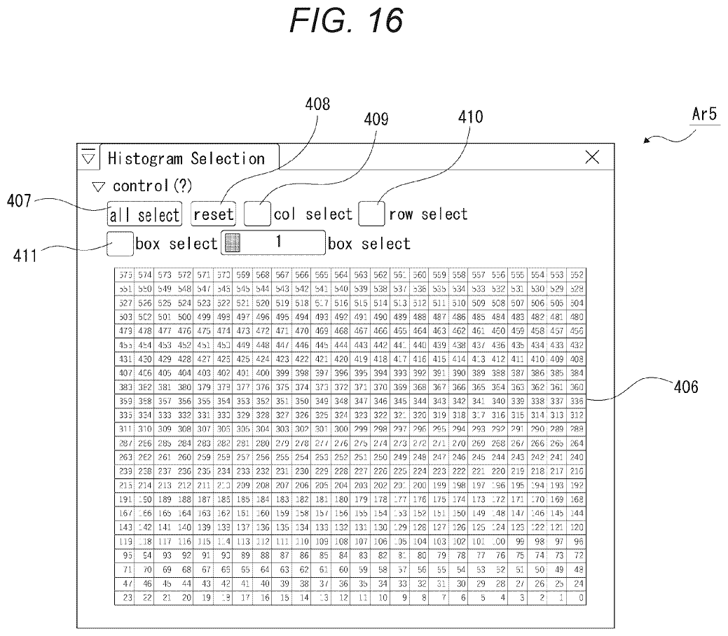

FIG. 16 is an enlarged view of the fifth area Ar5.

The fifth area Ar5 is provided with an individual selection field 406 in which the light receiving area ArR can be individually selected. Note that the individual selection field 406 can also be regarded as an area for individually selecting the small area ArS in the distance image G2 or an area for individually selecting the distance information DI (m, n).

In the individual selection field 406, serial IDs (0 to 575) are arranged in 576 rectangular fields that simulate the arrangement mode of the light receiving area ArR. By performing an operation of selecting each serial ID, it is possible to select a histogram to be displayed in the fourth area Ar4.

In addition, the fifth area Ar5 is provided with an all selection button 407 for selecting all the light receiving areas ArR and a reset button 408 for releasing the selected state in the individual selection field 406.

Moreover, in the fifth area Ar5, a column selection button 409 for collectively selecting one vertical column including the light receiving area ArR selected in the individual selection field 406, and a row selection button 410 for collectively selecting one horizontal column including the light receiving area ArR selected in the individual selection field 406 are disposed.

For example, when the user selects one light receiving area ArR in the individual selection field 406 after pressing the column selection button 409, one vertical column including the light receiving area ArR enters the selected state, and the histogram for the light receiving area ArR in the selected state is displayed in the histogram display area 401 of the fourth area Ar4.

Furthermore, in the fifth area Ar5, a box selection button 411 for selecting a plurality of the light receiving areas ArR in a rectangular box shape is disposed.

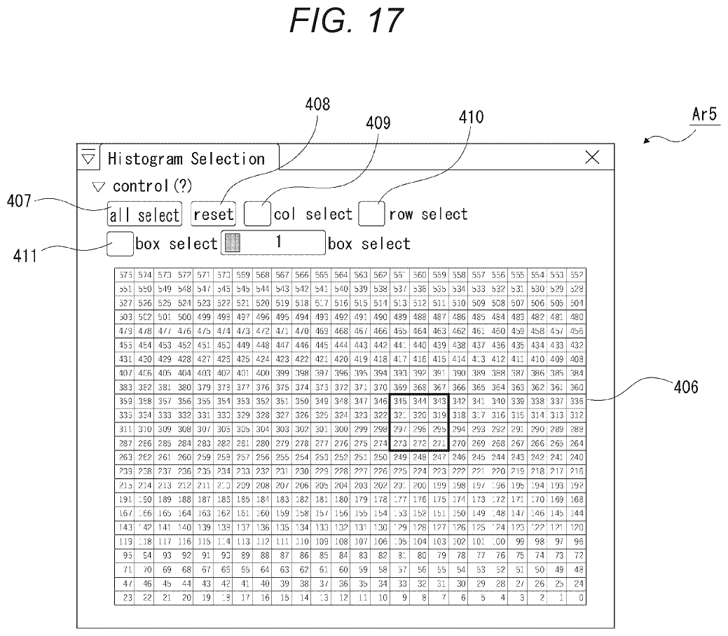

For example, by performing a drag operation on the individual selection field 406, the plurality of light receiving areas ArR is selected as illustrated in FIG. 17.

Note that it is also possible to select the light receiving area ArR to be displayed in the histogram display area 401 on the superimposed image G3 displayed in the first area Ar1.

The control unit 9 of the information processing device 1 in the present example has an assistance function for selecting an arbitrary icon image PF from a plurality of icon images PF densely displayed on the superimposed image G3.

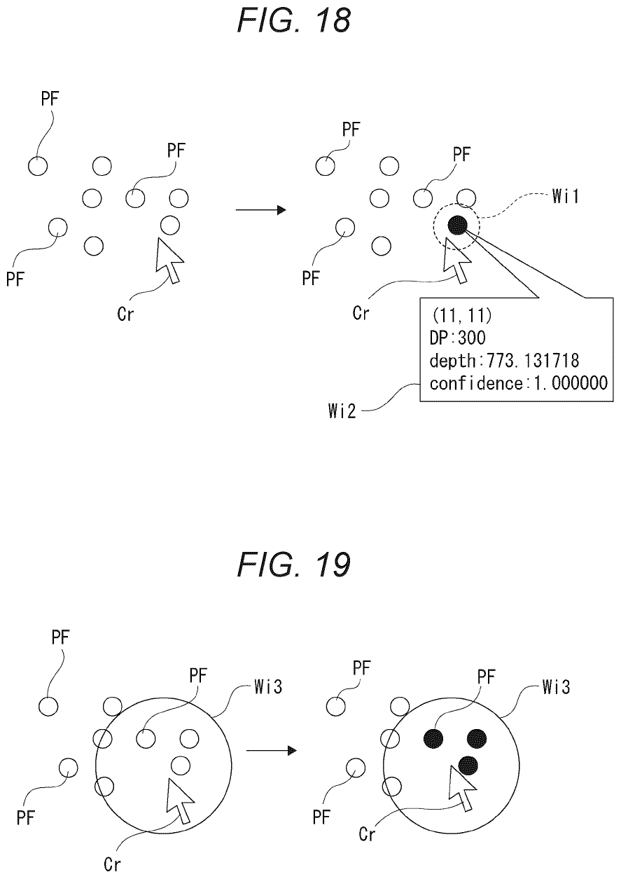

For example, FIG. 18 illustrates an example of an operation of selecting one of the plurality of icon images PF disposed on the superimposed image G3.

FIG. 18 is an enlarged diagram of a part of the superimposed image G3, and a plurality of icon images PF and a cursor Cr moving on the screen by a mouse operation of the user are displayed.

As illustrated in the left diagram of FIG. 18, when the cursor Cr is brought close to one icon image PF, as illustrated in the right diagram of FIG. 18, a circular broken line image Wi1 indicating that the icon image PF at the position closest to the cursor Cr is the object of the selection operation is superimposed so as to surround the icon image PF.

Furthermore, detailed distance information DI regarding the icon image PF to be selected on which the broken line image Wi1 is superimposed is superimposed and displayed in the vicinity of the icon image PF as a balloon image Wi2.

The balloon image Wi2 includes, for example, an x coordinate, a y coordinate (x and y are both integer values from 0 to 23.), a serial ID for the light receiving area ArR, distance information DI, and reliability information indicating the certainty of the distance in a balloon enclosure.

When the user performs a selection operation (for example, a mouse click operation) in the state illustrated in the left diagram of FIG. 18, the icon image PF at the position closest to the cursor Cr is selected, and the histogram according to the selection is displayed in a histogram display area 401 of the fourth area Ar4.

FIG. 19 illustrates an example of an operation of selecting a plurality of icon images PF from the plurality of icon images PF disposed on the superimposed image G3 as a mode different from that of FIG. 18.

The left diagram of FIG. 19 is the same as the left diagram of FIG. 18. In this example, a range image Wi3 indicating that the light receiving areas ArR included within a predetermined radius around the cursor Cr can be simultaneously selected is displayed.

Here, when the user performs a left click using a mouse for moving the cursor Cr, the icon image PF at the position closest to the cursor Cr is selected similarly to the above example. Then, a histogram according to the selected icon image PF is displayed in the histogram display area 401 of the fourth area Ar4.

On the other hand, when the user performs a right click using the mouse for moving the cursor Cr, a plurality of icon images PF included in the range image Wi3 are collectively selected. Then, a plurality of histograms according to the selected plurality of icon images PF is displayed in the histogram display area 401 of the fourth area Ar4.

As described above, various methods of selecting a histogram to be displayed in the histogram display area 401 of the fourth area Ar4 are prepared.

Furthermore, in a case where the control unit 9 of the information processing device 1 in the present example selects a histogram that the user wants to check, such as a characteristic histogram, the control unit 9 can execute processing of highlighting the light receiving area ArR in which the original data of the selected histogram has been acquired.

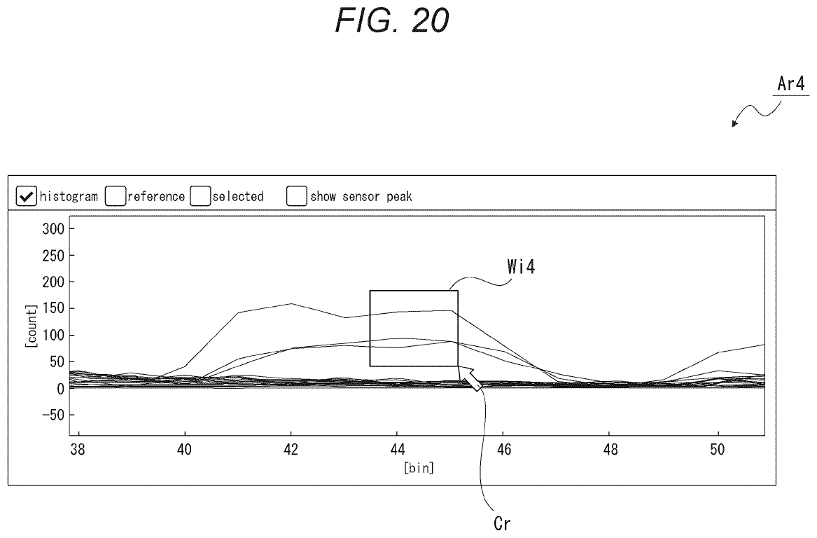

FIG. 20 illustrates an example of a histogram enlarged and displayed in the histogram display area 401 of the fourth area Ar4.

For example, when the user performs a drag operation using a mouse for moving the cursor Cr, the selected rectangular image Wi4 made into a rectangular square in FIG. 20 is displayed, and a histogram in which a part of the graph is included in the selected rectangular image Wi4 is brought into a selected state.

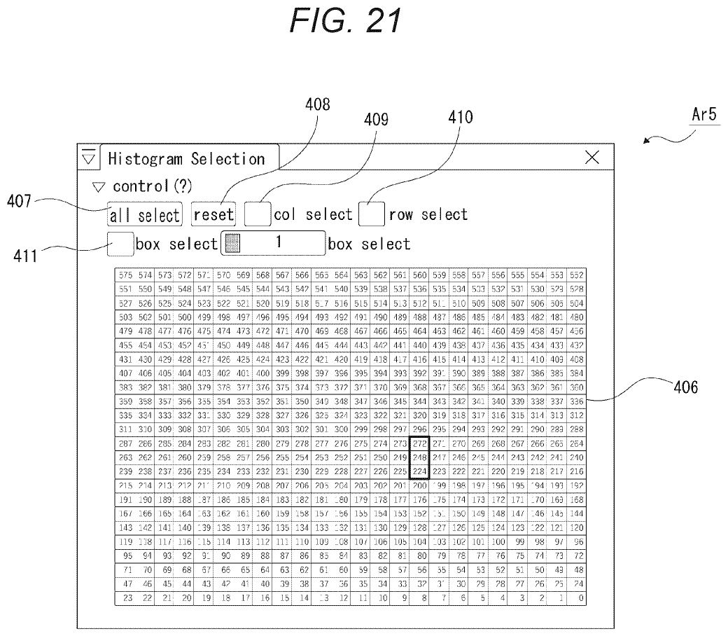

When some histograms are selected in the histogram display area 401, as illustrated in FIG. 21, the light receiving area ArR corresponding to the selected histogram is displayed in a highlighted manner in the individual selection field 406 in the fifth area Ar5.

Note that, instead of highlighting in the individual selection field 406 of the fifth area Ar5, the corresponding icon image PF may be highlighted on the superimposed image G3 of the first area Ar1, or the corresponding small area ArS may be highlighted on the distance image G2 of the second area Ar2. Furthermore, a plurality of highlighting may be performed simultaneously.

Therefore, it becomes easy to specify the light receiving area ArR in which the abnormal distance information is observed from the shape of the histogram, and the development efficiency of the distance measurement sensor 4Ba can be improved.

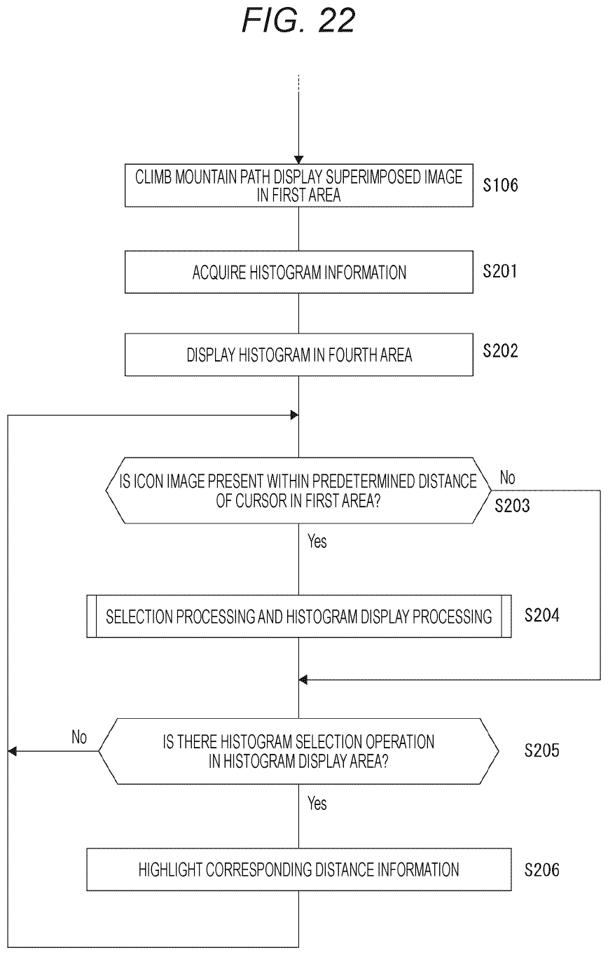

FIG. 22 illustrates an example of processing executed by the control unit 9 of the information processing device 1 in the present example. Note that the processing illustrated in FIG. 22 illustrates a part of the processing executed by each unit of the control unit 9, and the control unit 9 executes processing for detecting an operation performed by the user and processing corresponding to the user operation in addition to this.

Note that processing similar to that described so far will be denoted by the same step number, and description thereof will be omitted as appropriate.

The control unit 9 of the information processing device 1 executes each processing of step S101, step S102, step S103, step S104, step S105, and step S106 illustrated in FIG. 8 to cause the superimposed image G3 to be displayed in the first area Ar1 and the distance image G2 to be displayed in the second area Ar2 on the fourth screen 400.

Subsequently, in step S201 of FIG. 22, the control unit 9 acquires information for generating a histogram. The information for generating the histogram is individual unit distance information obtained from a plurality of imaging signals output from the distance measurement camera 4B, and is unit distance information obtained for each light emission of the light emitting element L.

In step S202, the display control unit 12 of the control unit 9 causes the histogram to be displayed in the histogram display area 401 of the fourth area Ar4.

In step S203, the control unit 9 determines whether or not the icon image PF is present within a predetermined distance of the cursor Cr in the first area Ar1. In other words, in step S203, the control unit 9 determines whether or not an operation of bringing the cursor Cr closer to the icon image PF within a predetermined distance has been detected.

In a case where it is determined that the icon image PF is present within the predetermined distance of the cursor Cr, the display control unit 12 of the control unit 9 performs, in step S204, processing of indicating that the icon image PF to be selected is selected and processing of causing only the histogram related to the selected icon image PF to be displayed in the histogram display area 401 of the fourth area Ar4.

After the processing in step S204 ends, or after it is determined in step S203 that the icon image PF is not present within the predetermined distance of the cursor Cr, the control unit 9 determines in step S205 the presence or absence of the histogram selection operation in the histogram display area 401.

In a case where it is determined that the histogram selection operation has been detected, the display control unit 12 of the control unit 9 highlights the distance information DI corresponding to the selected histogram in step S206. In the highlighting here, as described above, highlighting in the individual selection field 406 in the fifth area Ar5 may be performed, the corresponding icon image PF may be highlighted on the superimposed image G3 of the first area Ar1, or the corresponding small area ArS may be highlighted on the distance image G2 of the second area Ar2.

After step S206 ends or after it is determined in step S205 that the histogram selection operation has not been detected, the control unit 9 returns to the processing of step S203.

Here, two examples of the processing of step S204 will be described.

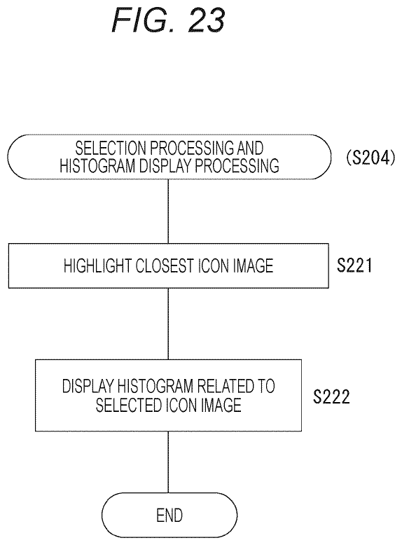

A first processing example is illustrated in FIG. 23.

The display control unit 12 of the control unit 9 highlights the icon image PF closest to the cursor Cr in step S221.

Next, the display control unit 12 of the control unit 9 causes the histogram related to the icon image PF selected in step S222 to be displayed in the histogram display area 401. After the processing of step S222, the control unit 9 ends the series of processing illustrated in FIG. 23.

This example is illustrated in FIG. 18.

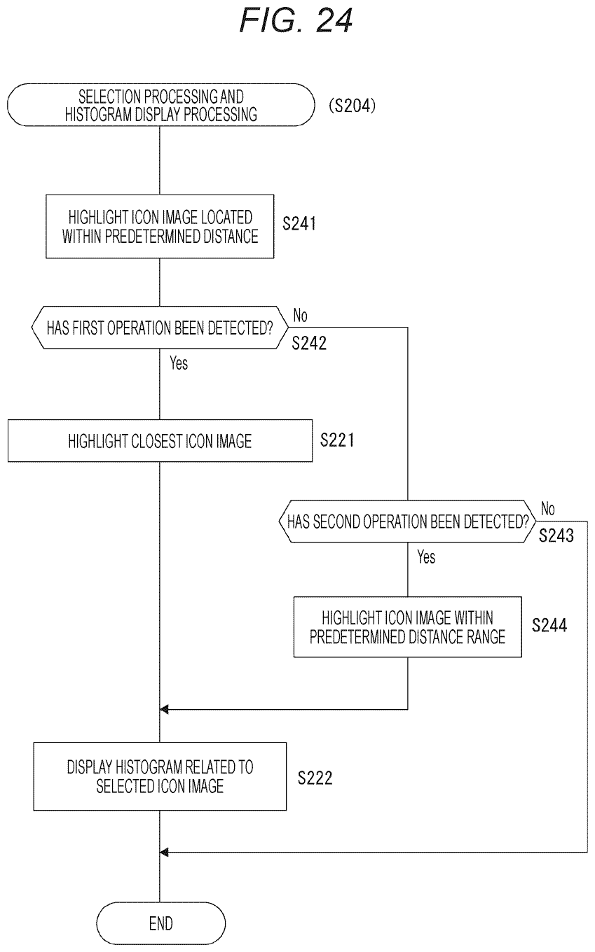

Next, a second processing example is illustrated in FIG. 24.

In step S241, the display control unit 12 of the control unit 9 highlights the icon image PF located within the predetermined distance of the cursor Cr.

The control unit 9 determines whether or not the first operation has been detected in step S242. The first operation here is, for example, a left click operation of the mouse as described above.

In a case where it is determined that the first operation has been detected, the display control unit 12 of the control unit 9 highlights the closest icon image PF in step S221 and causes the selection target histogram to be displayed in the histogram display area 401 in step S222, and ends the series of processing in FIG. 24.

In a case where it is determined in step S242 that the first operation has not been detected, the control unit 9 determines whether or not the second operation has been detected in step S243. The second operation here is, for example, a right click operation of the mouse as described above.

In a case where it is determined that the second operation has been detected, the display control unit 12 of the control unit 9 highlights the icon image PF within a predetermined distance range of the cursor Cr in step S244. Moreover, the display control unit 12 of the control unit 9 causes the selection target histogram to be displayed in the histogram display area 401 in step S222.

In a case where it is determined in step S242 that the first operation has not been detected and it is determined in step S243 that the second operation has not been detected, the display control unit 12 ends the series of processing illustrated in FIG. 24 without changing the display of the histogram.

This example is illustrated in FIG. 19.

### 3-5. Fifth Example

This example is an example in which the distance information DI as the time-series data having different acquisition timings and the distance information DI in the light receiving area ArR different in space are displayed by animation.

A fifth example of the screen displayed on the display unit Ma will be described.

A fifth screen 500 displayed on the display unit Ma in the fifth example includes a first area Ar1, a second area Ar2, a fourth area Ar4, and a fifth area Ar5 similarly to the fourth example.

Furthermore, since the configuration of each area is similar to that of the fourth example, the same reference signs as those of the fourth example will be used for description.

The information processing device 1 holds time series data about the distance information DI. Consequently, data having different acquisition timings is also stored as time-series data in the information processing device 1 for the histogram of the distance information DI. However, the present technology is not limited thereto, and the histogram as the time-series data may be acquired from the signal processing device 3 or another information processing device each time.

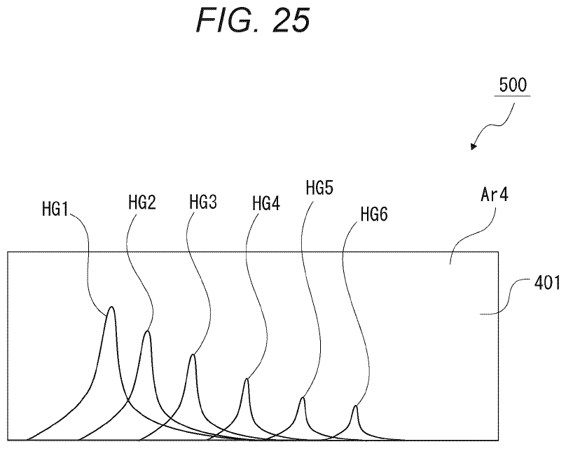

In a case where the operation of selecting one icon image PF displayed in the first area Ar1 on the fifth screen 500 is performed, histograms HG1, HG2, HG3, HG4, HG5, and HG6 are sequentially displayed with the lapse of time in the histogram display area 401 in the fourth area Ar4 as illustrated in FIG. 25. That is, in the histogram display area 401, animation display by the histograms HG1, HG2, HG3, HG4, HG5, and HG6 is performed.

Such animation display may be similarly performed in a case where an operation of selecting one small area ArS in the second area Ar2 or an operation of selecting one light receiving area ArR displayed in the individual selection field 406 in the fifth area Ar5 is performed.

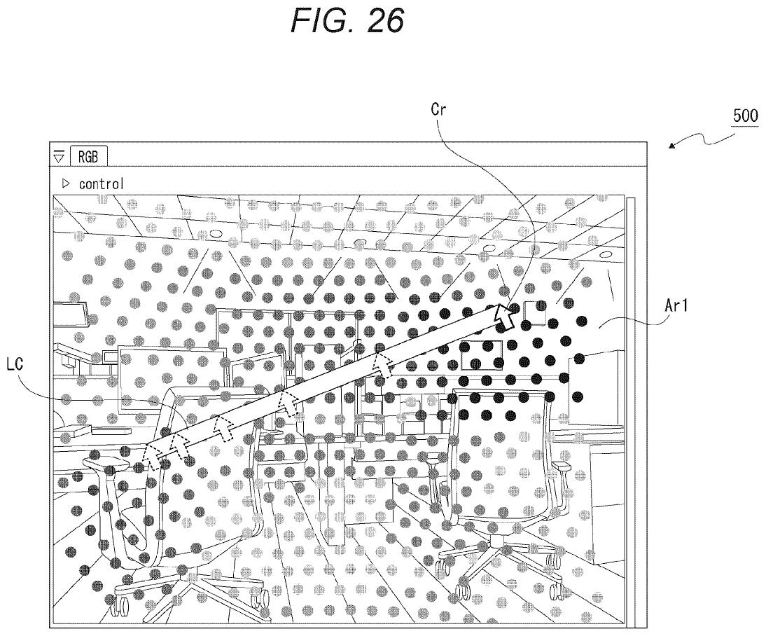

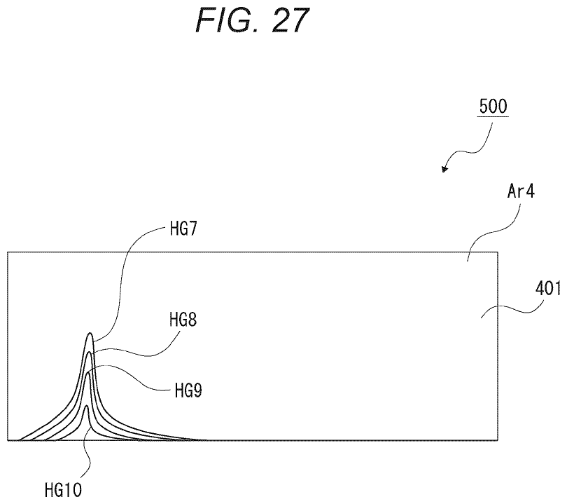

Furthermore, as illustrated in FIG. 26, in a case where the cursor Cr is moved so as to draw an arbitrary trajectory LC on the superimposed image G3 displayed in the first area Ar1 on the fifth screen 500, in the histogram display area 401 in the fourth area Ar4, the histograms HG1, HG2, HG3, HG4, HG5, HG6. of the icon image PF located in the vicinity of the trajectory LC of the cursor Cr may be displayed by animation as illustrated in FIG. 25.

At this time, the display order of the histograms HG1, HG2, HG3, HG4, HG5, and HG6 is the order in which the cursor Cr passes near the corresponding icon image PF.

By performing such animation display on the histogram display area 401, it is possible to check whether the histogram changes linearly according to the trajectory LC of the cursor Cr.

Furthermore, other animation display is also conceivable. For example, in a case where the distance information DI is obtained while changing the light emission intensity or the like of the light emitting element L included in the light emitting unit 4Bb of the distance measurement camera 4B, which is a parameter that affects the waveform of the histogram, for example, histograms HG7, HG8, HG9, and HG10 sequentially acquired along with the change in the light emission intensity in the histogram display area 401 in the fourth area Ar4 may be sequentially displayed as illustrated in FIG. 27.

By performing such animation display on the histogram display area 401, it is possible to visually check the influence of the parameter change on the distance measurement result.

Note that, with the change in the animation on the histogram display area 401, the display color of the icon image PF in the superimposed image G3 displayed in the first area Ar1 and the display color of the small area Ars in the distance image G2 displayed in the second area Ar2 may also be displayed by animation corresponding to the change in the distance. That is, each display color may change correspondingly each time the display of the histogram changes.

In such a display mode, there is a request to confirm the icon image PF and the small area ArS having a large change in display color. For example, the distance information DI acquired at a certain timing may be inappropriate data obtained as a result of receiving light reflected by an unintended object such as dust. In such a case, the display color is completely different by the distance information DI acquired at the timing in the animation display of the display color described above.

A function for assisting the selection operation for the distance information DI will be described.

As an example, an assistance function for selecting the icon image PF having a large change in the distance information DI in the first area Ar1 will be described.

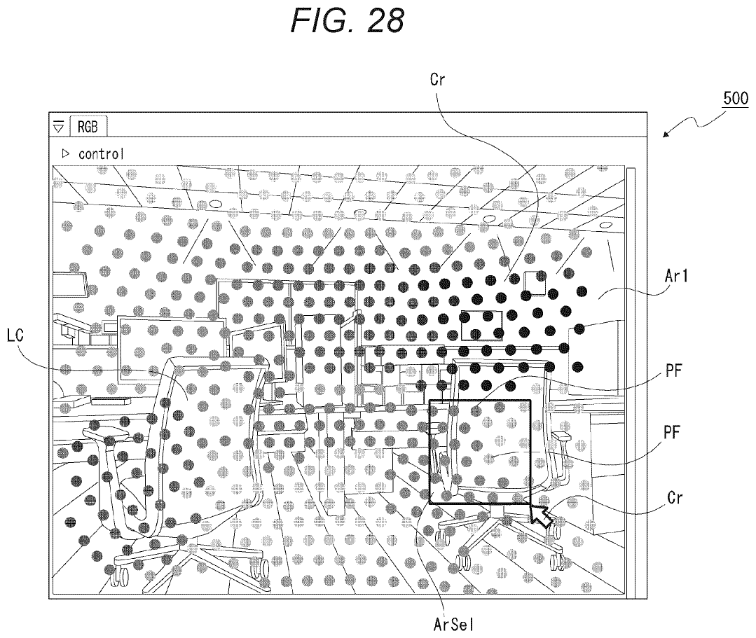

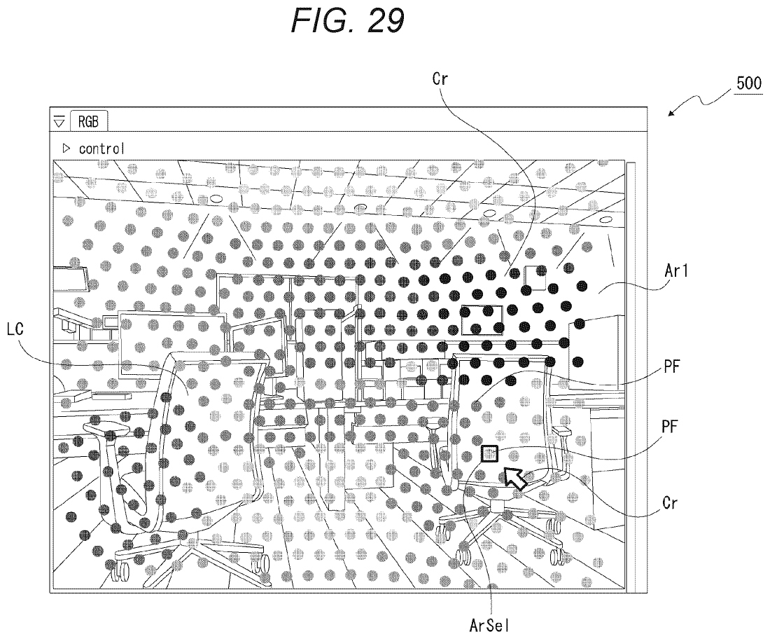

As illustrated in FIG. 28, when the user selects a predetermined range by performing a drag operation or the like using the cursor Cr, among the plurality of icon images PF included in the selected selection area ArSe1, the icon image PF having a large change in the distance information DI in the period from the start to the end of the animation is automatically selected (see FIG. 29).

At this time, in the histogram display area 401 of the fourth area Ar4, the histogram for the automatically selected icon image PF may be displayed (animation display may be performed). Furthermore, also in the second area Ar2, the small area ArS corresponding to the automatically selected icon image PF may be highlighted.

Such an assistance function can also be applied to a case where the user selects the small area ArS having a large change in display color at the time of animation in the second area Ar2.

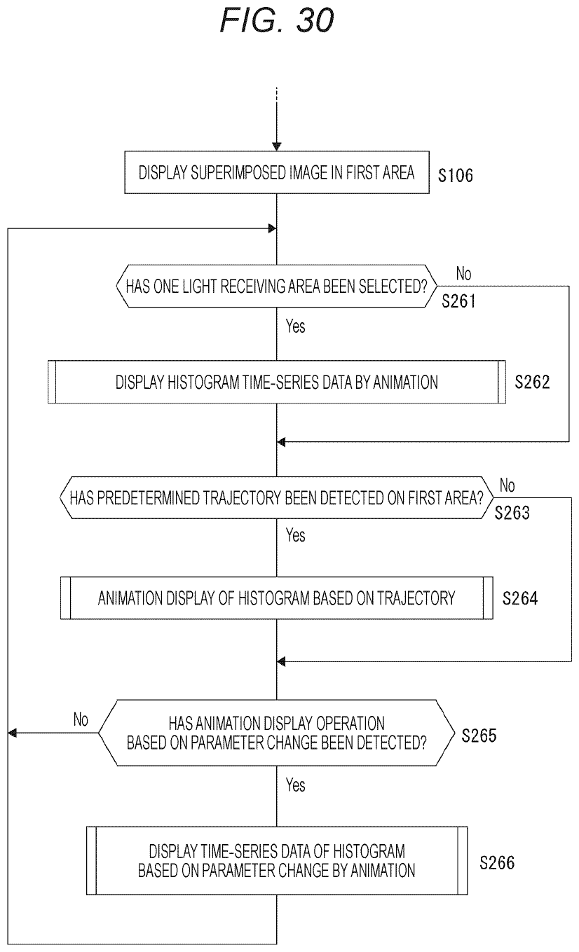

FIG. 30 illustrates an example of processing executed by the control unit 9 of the information processing device 1 in the present example. Note that the processing illustrated in FIG. 30 illustrates a part of the processing executed by each unit of the control unit 9, and the control unit 9 executes processing for detecting an operation performed by the user and processing corresponding to the user operation in addition to this.

Note that processing similar to that described so far will be denoted by the same step number, and description thereof will be omitted as appropriate.

The control unit 9 of the information processing device 1 executes each processing of step S101, step S102, step S103, step S104, step S105, and step S106 illustrated in FIG. 8 to cause the superimposed image G3 to be displayed in the first area Ar1 and the distance image G2 to be displayed in the second area Ar2 on the fifth screen 500.

The control unit 9 determines whether or not one light receiving area ArR has been selected in step S261. Specifically, the control unit 9 detects an operation of selecting one of the icon images PF displayed in the first area Ar1, an operation of selecting one of the small areas ArS in the second area Ar2, an operation of selecting one of the light receiving areas ArR displayed in the individual selection field 406 in the fifth area Ar5, and the like.

In a case where it is determined that the selection operation for the light receiving area ArR has been detected, the display control unit 12 of the control unit 9 causes the histogram time-series data for the light receiving area ArR to be selected to be displayed by animation in step S262 (see, for example, FIG. 25).

After step S262 or after it is determined that the selection operation has not been detected in step S261, the control unit 9 determines whether or not an operation of drawing a predetermined trajectory LC (see, for example, FIG. 26) on the first area Ar1 has been detected in step S263.

In a case where it is determined that the operation has been detected, the display control unit 12 of the control unit 9 causes animation display of the histogram based on the trajectory LC in step S264.

After step S264 or after determining that the operation of drawing the trajectory LC has not been detected in step S263, the control unit 9 determines whether or not the operation for displaying the animation based on the parameter change has been detected in step S265.

In a case where it is determined that the operation has been detected, the display control unit 12 of the control unit 9 causes animation display of the time-series data of the histogram based on the parameter change in step S266.

After step S266 or after it is determined in step S265 that the operation for displaying an animation has not been detected, the control unit 9 ends the series of processing illustrated in FIG. 30.

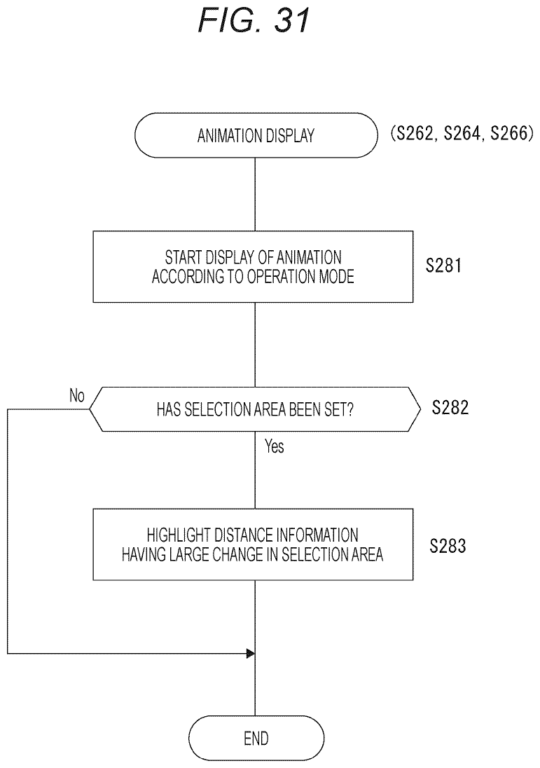

FIG. 31 illustrates each processing of steps S262, S264, and S266.

In step S281, the display control unit 12 of the control unit 9 causes display of an animation according to the operation mode to start. The animation display started here can be executed in different modes in steps S262, S264, and S266.

After the animation display starts, the control unit 9 determines in step S282 whether or not the selection area ArSe1 as illustrated in FIG. 28 has been set.

In a case where it is determined that the selection area ArSe1 has been set, the display control unit 12 of the control unit 9 causes the distance information DI having a large change in the selection area ArSe1 to be highlighted in step S283 (for example, see FIG. 29).

### 4. Others

The display modes of the first example, the second example, and the third example described above for the screen displayed on the display unit Ma may be switchable between displays.

For example, the arrangement of the first area Ar1, the second area Ar2, the third area Ar3, the fourth area Ar4, and the fifth area Ar5 may be freely settable by the user.

Alternatively, a menu for realizing the display mode in the first example, a menu for realizing the display mode in the second example, and the like may be provided, and display switching may be performed by appropriately selecting these menus.

### 5. Summary

As described in each of the examples described above, the information processing device 1 includes the display control unit 12 that causes the superimposed image G3 in which the distance information DI to a subject is superimposed on the luminance image G1 generated on the basis of luminance information about reflected light from the subject to be displayed in the first area Ar1 on the display unit Ma, and a superimposition position of the distance information DI on the luminance image G1 is set to be a position, on the luminance image G1, of the subject for which the distance information DI is obtained.

The luminance image G1 is, for example, a color image such as an RGB image, a monochrome image, or the like. Furthermore, the superimposition of the distance information DI may be performed by superimposing characters or by superimposing images.

By performing display on the display unit Ma of the display device M by such control by the display control unit 12, it is easy to grasp the correspondence between the luminance image G1 and the distance information DI at a glance. Consequently, by alternately displaying the luminance image G1 and the distance information DI, work efficiency can be improved as compared with a case where debugging work, manufacturing inspection, or the like at the time of development of the distance measurement sensor 4Ba is performed.

As described with reference to FIG. 6 and the like, the display control unit 12 in the information processing device 1 may cause the distance image G2 generated on the basis of the distance information DI to be displayed in the second area Ar2.

Therefore, the superimposed image G3 and the distance image G2 can be displayed side by side. Consequently, the work efficiency can be improved by comparing these images.

As described with reference to FIG. 6 and the like, the display control unit 12 in the information processing device 1 may cause the distance information DI for an image targeted for a selection operation among the distance information DI superimposed on the superimposed image G3 to be displayed in the third area Ar3.

Therefore, the detailed information of the distance information DI can be displayed in the third area Ar3.

Furthermore, it is possible to easily grasp which distance information DI on the superimposed image G3 the detailed information is. Therefore, the work efficiency can be further improved.

As described with reference to FIG. 4 and the like, the display control unit 12 in the information processing device 1 may superimpose the distance information DI on the luminance image G1 using the icon image PF reflecting the distance information DI, and a display color of the icon image PF is set according to a distance of the distance information DI.

By associating the display color with the distance, it is possible to grasp a relationship between the luminance image G1 and the distance information DI for the subject only at a glance.

Consequently, the work efficiency can be improved.

As described with reference to FIG. 7 and the like, the display control unit 12 in the information processing device 1 may change and display a correspondence relationship between the distance and the display color according to an operation.

Therefore, in a part of the distance range, the color change with respect to the distance change can be made non-linear. Consequently, the distance information DI can be inspected in more detail, and the efficiency of the debugging work of the distance measurement sensor 4Ba can be improved.

As described in the second example of the screen displayed on the display unit Ma with reference to FIGS. 9 and 10, the display control unit 12 in the information processing device 1 may cause the distance image G2 based on the distance information DI obtained for the subject to be displayed in one of the first area Ar1 and the second area Ar2, and cause the difference image G5 generated on the basis of a difference in the distance information (between distance information DI and reference distance information DIb) between the reference image G4 serving as a reference of the distance image G2 and the distance image G2 to be displayed in the other of the first area Ar1 and the second area Ar2.

The reference image G4 is a distance image generated by accurate distance information DI, and is an image to be obtained as the distance image G2. With the above-described configuration, it is possible to easily grasp a comparison result between the reference image G4 and the distance image G2 obtained by imaging, and to improve work efficiency.

As described in the second example of the screen displayed on the display unit Ma with reference to FIGS. 9, 10, and the like, the display control unit 12 in the information processing device 1 may switch from the difference image G5 to the distance image G2 according to a switching operation and cause the distance image to be displayed.

Therefore, it is possible to switch between a display mode suitable for the comparison between the distance image G2 and the reference image G4 and a display mode suitable for the comparison between the distance image G2 and the difference image G5 according to the situation.

Consequently, it is possible to efficiently perform debugging work of the distance measurement sensor 4Ba from various viewpoints.

As described in the second example of the screen displayed on the display unit Ma with reference to FIGS. 9, 10, and the like, the display control unit 12 in the information processing device 1 may cause the operator (switch button 201) for the switching operation to be displayed.

Therefore, a plurality of display modes can be easily switched by, for example, a click operation.

As described in the second example of the screen displayed on the display unit Ma with reference to FIGS. 9, 10, and the like, the display control unit 12 in the information processing device 1 may cause difference information of a distance corresponding to an area targeted for a selection operation on the difference image G5 to be displayed in the third area Ar3.

Therefore, the difference between the distance information (the distance information DI and the reference distance information DIb) in the area selected for the distance image G2 and the reference image G4 can be confirmed in detail in the third area Ar3.

That is, the work efficiency can be improved using more information.

As described in the third example of the screen displayed on the display unit Ma with reference to FIGS. 11 and 12, the display control unit 12 in the information processing device 1 may cause the emphasis image Wi for emphasizing an area in which a difference in distance information (between the distance information DI and the reference distance information DIb) between the distance image G2 and the reference image G4 is greater than or equal to a predetermined value to be superimposed and displayed for at least one of the distance image G2 and the reference image G4.

Therefore, it is possible to grasp an area having a difference at a glance, and the work efficiency is improved. The emphasis image Wi is, for example, a circular image surrounding the corresponding area.

As described in the third example of the screen displayed on the display unit Ma with reference to FIG. 11, the display control unit 12 in the information processing device 1 may cause the distance information DI about an area on which the emphasis image Wi is superimposed according to a selection operation on the emphasis image Wi to be displayed in the third area Ar3.

That is, by performing a click operation or the like on the emphasis image Wi, the difference information for the area can be presented in the third area Ar3.

Consequently, the user can easily confirm the difference information. Furthermore, in a case where a plurality of the emphasis images Wi is superimposed on a plurality of areas, information displayed in the third area Ar3 can be easily switched by performing a click operation for switching selection of the plurality of emphasis images Wi.

As described in the third example of the screen displayed on the display unit Ma with reference to FIGS. 13 and 14, the display control unit 12 in the information processing device 1 may cause the operator (switch button 302) for a switching operation for switching display to be displayed, and switch an image to be displayed in an area where the reference image G4 is displayed between the reference image G4 and the distance image G2 according to an operation of the operator (switch button 302).

Therefore, for example, the image displayed in the second area Ar2 can be switched between the reference image G4 and the distance image G2. That is, since the image displayed in the same area is switched for each switching operation, it is possible to easily grasp the difference between the reference image G4 and the distance image G2.

As described in the fourth example of the screen displayed on the display unit Ma with reference to FIG. 18 and the like, the display control unit 12 in the information processing device 1 may cause the cursor Cr to be displayed at a position on the display unit Ma according to a user operation, and cause the distance information DI near a display position of the cursor Cr out of the distance information DI superimposed on the luminance image G1 to be highlighted on the superimposed image G3.

Therefore, even in a case where the distance information DI is densely superimposed, the user can easily select any distance information DI.

As described in the fourth example and the fifth example of the screen displayed on the display unit Ma with reference to each of FIGS. 15 to 25, the display control unit 12 in the information processing device 1 may cause a histogram for the distance information DI superimposed on the luminance image G1 to be displayed in the fourth area Ar4.

Specifically, the light reception in the light receiving pixel of the distance measurement sensor 4Ba and the calculation of the unit distance information are performed a plurality of times to obtain a plurality of pieces of the unit distance information. Then, in the histogram, the plurality of pieces of unit distance information is expressed as frequency information.

Therefore, variations in distance measurement information and the like can be visually confirmed, which contributes to improvement in efficiency of debugging work.

As described in the fourth example of the screen displayed on the display unit Ma with reference to FIGS. 20 and 21, the display control unit 12 in the information processing device 1 may cause a histogram for each of a plurality of pieces of the distance information DI superimposed on the luminance image G1 to be displayed in the fourth area Ar4, and cause the distance information DI corresponding to some histograms selected in the fourth area Ar4 to be highlighted.

Therefore, in a case where a characteristic histogram is mixed in a plurality of the histograms, it is possible to specify an approximate pixel position where such distance information DI is obtained.

As described in the fifth example of the screen displayed on the display unit Ma with reference to FIGS. 28, 29, 31, and the like, the display control unit 12 in the information processing device 1 may cause the distance information DI having a large change in distance out of the distance information DI located in the selection area ArSe1 selected by a selection operation of selecting a partial area on the superimposed image G3 to be highlighted.

For example, in a case where reproduction display is performed so as to display the histograms of the plurality of pieces of distance information DI in chronological order, the distance information DI having a large temporal change is highlighted in the selection area ArSe1.

Alternatively, in a case where the selection area ArSe1 is set on the superimposed image G3, the distance information DI having a large difference from the reference image G4 may be highlighted.

Therefore, the distance information DI to be confirmed in detail is automatically emphasized only by roughly setting the selection area ArSe1, and the work efficiency can be further improved.

As described with reference to FIGS. 4 and 5 and the like, in the information processing device 1, the distance information DI may be obtained by a ToF method using the light emitting unit 4Bb and the light receiving unit (distance measurement sensor 4Ba), and the superimposition position of the distance information DI on the luminance image G1 may be set to a position obtained by performing processing of converting the light receiving position (light receiving area ArR) of reflected light from the subject in the light receiving unit (distance measurement sensor 4Ba) into a position on the luminance image G1.

Therefore, the position on the distance image G2 corresponding to the distance information DI and the position on the luminance image G1 are more accurately associated with each other.

Consequently, since the distance information DI can be accurately superimposed on the luminance image G1 for the subject, debugging work can be easily performed, and efficiency can be improved.

The information processing method executed by the information processing device 1 includes processing of causing the superimposed image G3 in which the distance information DI to a subject is superimposed on the luminance image G1 generated on the basis of luminance information about reflected light from the subject to be displayed in the first area Ar1 on the display unit Ma, and a superimposition position of the distance information DI on the luminance image G1 is set to be a position, on the luminance image G1, of the subject for which the distance information DI is obtained.

A program according to the present technology is a program to be executed by an arithmetic processing device, the program including processing of causing a superimposed image G3 in which the distance information DI to a subject is superimposed on the luminance image G1 generated on the basis of luminance information about reflected light from the subject to be displayed in the first area Ar1 on the display unit Ma, in which a superimposition position of the distance information DI on the luminance image G1 is set to be a position, on the luminance image G1, of the subject for which the distance information DI is obtained.

The above-described various actions and effects can be obtained by such information processing method and program.

Such programs can be recorded in advance in a hard disk drive (HDD) as a recording medium built in a device such as a computer device, a ROM in a microcomputer having a CPU, or the like. Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program can be installed from the removable recording medium into the personal computer and the like, or can be downloaded from a download site through a network such as a local area network (LAN) or the Internet.

Note that, the effects described in the present specification are merely examples and are not limited, and other effects may be provided.

Furthermore, the above-described examples may be combined in any way, and the above-described various functions and effects may be obtained even in a case where various combinations are used.

### 6. Present Technology

The present technology can also adopt the following configurations.
(1) An information processing device including
a display control unit that causes a superimposed image in which distance information to a subject is superimposed on a luminance image generated on the basis of luminance information about reflected light from the subject to be displayed in a first area on a display unit,
in which a superimposition position of the distance information on the luminance image is set to be a position, on the luminance image, of the subject for which the distance information is obtained.
(2) The information processing device according to (1) described above, in which
the display control unit causes a distance image generated on the basis of the distance information to be displayed in a second area.
(3) The information processing device according to any one of (1) to (2) described above, in which
the display control unit causes the distance information for an image targeted for a selection operation among the distance information superimposed on the superimposed image to be displayed in a third area.
(4) The information processing device according to any one of (1) to (3) described above, in which
the display control unit superimposes the distance information on the luminance image using an icon image reflecting the distance information, and
a display color of the icon image is set according to a distance of the distance information.
(5) The information processing device according to (4) described above, in which
the display control unit changes and displays a correspondence relationship between the distance and the display color according to an operation.
(6) The information processing device according to (2) described above, in which
the display control unit causes the distance image based on the distance information obtained for the subject to be displayed in one of the first area and the second area, and causes a difference image generated on the basis of a difference in distance information between a reference image serving as a reference of the distance image and the distance image to be displayed in another of the first area and the second area.
(7) The information processing device according to (6) described above, in which
the display control unit switches from the difference image to the distance image according to a switching operation and causes the distance image to be displayed.
(8) The information processing device according to (7) described above, in which
the display control unit causes an operator for the switching operation to be displayed.
(9) The information processing device according to any one of (6) to (8) described above, in which
the display control unit causes difference information of a distance corresponding to an area targeted for a selection operation on the difference image to be displayed in a third area.
(10) The information processing device according to (6) described above, in which
the display control unit causes an emphasis image for emphasizing an area in which a difference in distance information between the distance image and the reference image is greater than or equal to a predetermined value to be superimposed and displayed for at least one of the distance image and the reference image.
(11) The information processing device according to (10) described above, in which
the display control unit causes the distance information about an area on which the emphasis image is superimposed according to a selection operation on the emphasis image to be displayed in a third area.
(12) The information processing device according to any one of (10) to (11) described above, in which
the display control unit
causes an operator for a switching operation for switching display to be displayed, and
switches an image to be displayed in an area where the reference image is displayed between the reference image and the distance image according to an operation of the operator.
(13) The information processing device according to any one of (1) to (12) described above, in which
the display control unit
causes a cursor to be displayed at a position on the display unit according to a user operation, and
causes the distance information near a display position of the cursor out of the distance information superimposed on the luminance image to be highlighted on the superimposed image.
(14) The information processing device according to any one of (1) to (13) described above, in which
the display control unit causes a histogram for the distance information superimposed on the luminance image to be displayed in a fourth area.
(15) The information processing device according to (14) described above, in which
the display control unit
causes a histogram for each of a plurality of pieces of the distance information superimposed on the luminance image to be displayed in the fourth area, and
causes the distance information corresponding to some histograms selected in the fourth area to be highlighted.
(16) The information processing device according to any one of (1) to (15) described above, in which
the display control unit
causes the distance information having a large change in distance out of the distance information located in a selection area selected by a selection operation of selecting a partial area on the superimposed image to be highlighted.
(17) The information processing device according to any one of (1) to (16) described above, in which
the distance information is obtained by a ToF method using a light emitting unit and a light receiving unit, and
the superimposition position of the distance information on the luminance image is set to a position obtained by performing processing of converting a light receiving position of reflected light from the subject in the light receiving unit into a position on the luminance image.
(18) A program to be executed by an arithmetic processing device, the program including:
processing of causing a superimposed image in which distance information to a subject is superimposed on a luminance image generated on the basis of luminance information about reflected light from the subject to be displayed in a first area on a display unit,
in which a superimposition position of the distance information on the luminance image is set to be a position, on the luminance image, of the subject for which the distance information is obtained.
(19) An information processing method performed by an information processing device, the information processing method including:
processing of causing a superimposed image in which distance information to a subject is superimposed on a luminance image generated on the basis of luminance information about reflected light from the subject to be displayed in a first area on a display unit,
in which a superimposition position of the distance information on the luminance image is set to be a position, on the luminance image, of the subject for which the distance information is obtained.

### REFERENCE SIGNS LIST

1 Information processing device
12 Display control unit
201 Switch button (operator)
302 Switch button (operator)
Ar1 First area
Ar2 Second area
Ar3 Third area
Ar4 Fourth area
ArSe1 Selection area
Cr Cursor
DI Distance information
G1 Luminance image
G2 Distance image
G3 Superimposed image
G4 Reference image
G5 Difference image
Ma Display unit
PF Icon image
Wi Emphasis image

1. An information processing device comprising
a display control unit that causes a superimposed image in which distance information to a subject is superimposed on a luminance image generated on a basis of luminance information about reflected light from the subject to be displayed in a first area on a display unit, wherein
a superimposition position of the distance information on the luminance image is set to be a position, on the luminance image, of the subject for which the distance information is obtained.

2. The information processing device according to claim 1, wherein
the display control unit causes a distance image generated on a basis of the distance information to be displayed in a second area.

3. The information processing device according to claim 1, wherein
the display control unit causes the distance information for an image targeted for a selection operation among the distance information superimposed on the superimposed image to be displayed in a third area.

4. The information processing device according to claim 1, wherein
the display control unit superimposes the distance information on the luminance image using an icon image reflecting the distance information, and
a display color of the icon image is set according to a distance of the distance information.

5. The information processing device according to claim 4, wherein
the display control unit changes and displays a correspondence relationship between the distance and the display color according to an operation.

6. The information processing device according to claim 2, wherein
the display control unit causes the distance image based on the distance information obtained for the subject to be displayed in one of the first area and the second area, and causes a difference image generated on a basis of a difference in distance information between a reference image serving as a reference of the distance image and the distance image to be displayed in another of the first area and the second area.

7. The information processing device according to claim 6, wherein
the display control unit switches from the difference image to the distance image according to a switching operation and causes the distance image to be displayed.

8. The information processing device according to claim 7, wherein
the display control unit causes an operator for the switching operation to be displayed.

9. The information processing device according to claim 6, wherein
the display control unit causes difference information of a distance corresponding to an area targeted for a selection operation on the difference image to be displayed in a third area.

10. The information processing device according to claim 6, wherein
the display control unit causes an emphasis image for emphasizing an area in which a difference in distance information between the distance image and the reference image is greater than or equal to a predetermined value to be superimposed and displayed for at least one of the distance image and the reference image.

11. The information processing device according to claim 10, wherein
the display control unit causes the distance information about an area on which the emphasis image is superimposed according to a selection operation on the emphasis image to be displayed in a third area.

12. The information processing device according to claim 10, wherein
the display control unit
causes an operator for a switching operation for switching display to be displayed, and
switches an image to be displayed in an area where the reference image is displayed between the reference image and the distance image according to an operation of the operator.

13. The information processing device according to claim 1, wherein
the display control unit
causes a cursor to be displayed at a position on the display unit according to a user operation, and
causes the distance information near a display position of the cursor out of the distance information superimposed on the luminance image to be highlighted on the superimposed image.

14. The information processing device according to claim 1, wherein
the display control unit causes a histogram for the distance information superimposed on the luminance image to be displayed in a fourth area.

15. The information processing device according to claim 14, wherein
the display control unit
causes a histogram for each of a plurality of pieces of the distance information superimposed on the luminance image to be displayed in the fourth area, and
causes the distance information corresponding to some histograms selected in the fourth area to be highlighted.

16. The information processing device according to claim 1, wherein
the display control unit
causes the distance information having a large change in distance out of the distance information located in a selection area selected by a selection operation of selecting a partial area on the superimposed image to be highlighted.

17. The information processing device according to claim 1, wherein
the distance information is obtained by a ToF method using a light emitting unit and a light receiving unit, and
the superimposition position of the distance information on the luminance image is set to a position obtained by performing processing of converting a light receiving position of reflected light from the subject in the light receiving unit into a position on the luminance image.

18. A program to be executed by an arithmetic processing device, the program comprising:
processing of causing a superimposed image in which distance information to a subject is superimposed on a luminance image generated on a basis of luminance information about reflected light from the subject to be displayed in a first area on a display unit,
wherein a superimposition position of the distance information on the luminance image is set to be a position, on the luminance image, of the subject for which the distance information is obtained.

19. An information processing method performed by an information processing device, the information processing method comprising:
processing of causing a superimposed image in which distance information to a subject is superimposed on a luminance image generated on a basis of luminance information about reflected light from the subject to be displayed in a first area on a display unit,
wherein a superimposition position of the distance information on the luminance image is set to be a position, on the luminance image, of the subject for which the distance information is obtained.
